(19) United States
(12) Patent Application Publication
(10) Pub. No.: US 2011/0088164 A1
(43) Pub. Date: Apr. 21, 2011

(54) Multi-purpose Hospital Bed

(76) Inventors: Mohammad Hassan Mahdjoubi, Woodland Hills, CA (US); Ezatolah Dayanifar, Tehran (IR)

(21) Appl. No.: 12/875,141

(22) Filed: Sep. 3, 2010

Related U.S. Application Data
(63) Continuation-in-part of application No. 11/309,498, filed on Aug. 14, 2006, now Pat. No. 7,818,831.

(51) Int. Cl. A61G 7/10; A47G 9/02

(52) U.S. Cl. 5/81.1 R

(57) ABSTRACT

Disclosed is a method for transferring a patient from a first bed to a second bed, wherein said patient is disposed upon said first bed and said first bed and second bed comprise a surface for resting said patient comprising a plurality of predetermined sections. The method further discloses removing at least one of said plurality of predetermined sections of said surface of said first bed and replacing it with at least one of said plurality of predetermined sections of said surface of said second bed and removing at least one of said plurality of predetermined sections of said surface of said second bed and replacing it with at least one of said plurality of predetermined sections of said surface of said first bed; combining said surface of said first bed with said surface of said second bed; and transferring said patient from said first bed to second bed.

### CROSS REFERENCE TO RELATED APPLICATIONS

This application is Continuation in Part of U.S. patent application Ser. No. 11/309,498 by Mandjoubi et al filed Aug. 16, 2006.

### FIELD OF THE INVENTION

The present invention relates to a transfer and transport system for immobile prone patients in addition to having the means to facilitate air flow under a patient's back for the prevention of bed sores. Another beneficial object of the invention refers to the means whereby linen on a patient's support surface is conveniently changed with ease and without the necessity of moving the patient.

### BACKGROUND OF THE INVENTION

All medical facilities have part of their routine the constant transfer of patients from one support surface such as a permanently-placed hospital bed to another support surface such as another bed, a gurney or any other maneuverable support surface. This is inevitable because of the need for patients to be moved to other sections of the medical facility for surgery, further medical tests, x-rays and scans, the soaking of burn victims in water tubs, and etc. The transfer can be very uncomfortable and painful for the patients and may require a number of medical personnel to facilitate the transfer especially with immobile and heavy patients.

Depending on how advanced facilities in a medical establishment are, non-ambulatory patients are moved in various ways. Often, several personnel are required to lift the patient at one time from one bed to another, usually a wheeled contraption, or to a wheelchair before being transported to another section of the medical facility. This leads to work-related complaints from nurses and medical attendants because of back injuries incurred.

Innovations have been attempted to facilitate the easy transfer and transport of immobile and critically-ill patients. Hoist-type lifts wherein patients are suspended in a sling have been used but this entails positioning the sling under the patient first then physically lifting the patient which results in the change of the patient's body position and the application of pressure points other than those applied when in a prone position. This can be very uncomfortable for patients, particularly orthopedic and burn patients. A similar system is the use of roller boards which, again, have to be positioned under a patient before transport and yet may not be able to securely keep the patient in place.

Other prior transfer devises have not been able to accomplish the transfer of patients in the smoothest pain-free manner possible. There have been conveyors introduced which may serve the purpose but would not be able to accommodate different-sized beds. These devises are set forth in U.S. Pat. Nos. 5,163,189; 4,776,047; 4,761,841; 3,769,642; 3,593,351; 3,413,663; 3,302,219; 2,733,452; 2,630,583; 2,536,707; 1,487,171; 1,263,611; 716,886; and 378,220. Likewise, US patents to DiMatteo and DiMatteo et al entails transferring a prone patient between a bed and another horizontal support by webs which move independently in a lateral direction; but, since the webs are in no way connected, the two support surfaces must be separated from each other during the transfer operation so that the movements of both webs do not interfere with each other. Therefore, the gap between both support surfaces would mean a lapse of support for the patient. In U.S. Pat. No. 4,747,170 to Knouse, a web attaches to the edge of the sheet on the patient's bed so that as the web is wound onto a roller it pulls the sheet, and thereby the patient, onto an adjacent support surface. But to do the vice-versa must be done from the other side of the bed which may not be accessible to the patient mover.

Carter, et al in U.S. Pat. No. 5,038,424, has improved on these other systems as described above by inventing a transfer system consisting of two support surfaces with the use of pliable webs, the opposite ends of which are wound about a pair of cylindrical rollers and driven by motors which are hydraulic. Another U.S. Pat. No. 6,591,435 to Hodgetts is similar in the sense that it transports a patient from a bed to a stretcher or vice versa through the use of a bed sheet and a conveyor attached to the bed or the stretcher. A first end of the sheet is removably attached to the conveyor and a second end of the sheet is free. The sheet is adapted to be positioned onto the patient supporting member of the bed or stretcher. The conveyor includes a roller received by bearings. The roller can also include a telescopic arrangement so that its length can be adjusted.

Needless to say, all these contraptions cause discomfort and even pain to the patients being transferred and transported and would not work conveniently for patients in very serious condition. Movements incurred by transferring and transporting patients through such methods may even adversely affect their recovery.

Although this invention and its embodiments has as its primary purpose the convenient transfer of patients from one support surface to another with the minimum, if not zero, movement of the patient, there are secondary purposes which include the allowance of space and facilitation of air flow under a continuously-prone immobile patient to prevent bed sores; and, the convenient changing of bed sheets under an immobile patient which would ensure a hygienic environment for a critically-ill person forced to stay in hospital for a long period of time.

Those long-staying patients in medical facilities are often those who are critically ill, critically burned, comatose, or require surgical operations one after the other. Most often they are in a continual prone position subjecting them to the prevalence of pressure sores. Low air loss patient support structures or beds have been known in the medical field for the prevention and treatment of pressure sores. Support Systems International, Inc. has come up with exemplary low air loss beds relating to wound care management and prevention like their Flexicair and Restcue beds. Alternating pressure low air loss beds are also known; for example, U.S. Pat. No. 5,044,029 to Vrzalik which has air bags positioned alternatively in an inter-digital manner. For this purpose, this present invention would not need any other extra accessory. The planks can be lowered down and away or lowered to the sides and away from the patient's back in an alternating manner to facilitate air flow so that there would still be ample support under the patient whilst permitting air to circulate freely to the skin.

Again, for long-staying patients to which the slightest movement may cause excruciating pain, there is a need for a system to change bed linen with ease. Routine in hospital is to fold a linen lengthwise and position it along the length of the patient with the folded side pushed a little under the patient's back. Then the patient is turned a little in order to pull the other side of the sheet from underneath. This works only for patients that can be moved without entailing pain. However, this present invention includes 2 or 3-dimensional planks laid inter-digitally in 2 palettes to give a complete support surface to the patient but each plank, being separate from each other, can thus be fitted with a separate fitted sheet, also 2 or 3-dimensional. Therefore, they can be rotated periodically so that a clean side is always under the patient until such time that all two or three sides have been soiled and would necessitate its change

Although this invention utilizes wooden or aluminum material or any other similar and suitable material to substitute, the planks can also be in the form of air bags which can be inflated or deflated alternatively to fit the purpose of the support surface. In this case, a pneumatic system needs to be introduced and changes made to the apparatus to accommodate such changes. The apparatus can also be changed from being manually operated to being powered, whether by electric, hydraulic, pneumatic, or whatever suitable energy.

This device to transfer and transport patients will be simple to operate and maintain and would not conflict with the other portions of the medical system; thus accomplishing the transfer and transport of patients from one location to another in a medical establishment in an efficient pain-free manner by a minimum of personnel.

### SUMMARY OF THE INVENTION

This invention is an apparatus to transfer and transport patients consisting of two similar support surfaces for receiving and supporting a patient before transportation to another location for any purpose deemed necessary by medical staff. They may be maneuverable or set on the floor in a permanent manner depending on whether it is to transport a patient or not. Such systems should be accessible in radiology, burn units, testing units and other sections of the medical establishment for the easy, pain-free and convenient maneuvering of patients.

The support surfaces of these hospital beds would consist of two palettes each made of a series of rectangular 2-dimensional or triangular 3-dimensional planks inter-digitally positioned. Each palette can be moved interchangeably downwards to the sides, or straight down, and away from a patient's back. The two beds are placed beside each other's free side and when a palette of one bed is lowered down, the corresponding palette of the other where the patient is to be transferred is raised up to fill the void created by the lowering down of the previous palette. This is repeated until both palettes of one bed have taken the place of the palettes of the other bed thereby completing the new support surface where the patient lays. No movement is required from the patient nor any movement caused to the body. The maneuverable bed can then be moved away from the other to transport the patient to any location in the medical facility as desired.

In accordance with the embodiments of the system and as mentioned above, there are two similarly-designed support surfaces or hospital beds to support and receive a prone immobile patient for eventual transport to another section of a medical establishment and these two hospital beds are of 2 different kinds, one being stable and the other maneuverable for the transport of the patient. Both beds in this invention are operated manually but it is open to the possibility of changing the system from being manual to being pneumatic, hydraulic, electrical, or whatever with the addition of accessories like motors, gears, air and oil jacks, etc. The stable bed rests upon a strong structure made of any durable hard material. The head in each end of the bed has an arch under which are connecting sections running from one side of the structure to the other to make the structure more stable. The maneuverable bed likewise rests on an equally strong structure made of any durable hard material just like the stable bed but the base of the maneuverable bed has wheels attached to the base structure to enable the transport and transfer of patients to another location in the medical establishment.

An aspect of this invention is that each of the 2 beds which compose this system has 2 palettes each composed of 2-dimensional rectangular or 3-dimensional triangular planks placed in an inter-digital manner (i.e. there is equal space between each plank). At the sides of the bed heads are holes to which each opposite ends of one palette are attached. Corresponding holes also hold firmly in place the other palette. There are holes in both stable and maneuverable beds to which are positioned locking pins which have been set on corresponding holes in each opposite side to serve as locking mechanisms and to keep the palettes in place.

Embodiments of this invention include the fact that the two palettes in the stable bed are similar to the palettes of the maneuverable bed. One is composed of an axle rod which holds it in place to the base of the bed and on each end of the axle rod are two grooves wherein one is bored beside the handle end of the axle rod and one at the other end. To ensure the permanent stable position of the axle rod to the base structure of the bed there are 2 curved pins in place inside the grooves. The Axle rod is firmly set into the grooves. This one palette has approximately seven strong rods each having one end attached to the axle rod attached to the bed structure base while the other end is free to enable the sliding in of a plank. On each rod end are 3 holes angled equally (120 degrees) to each other to which a metal ball bearing assembly positioned on the hole of a plank is set to ensure the stable positioning of the plank on the rod and to prevent unwanted movements. The handle end is attached to the axle rod for easy and convenient manual rotating work. At the end of this handle is a hole to which a locking pin is positioned. Likewise, there is a plastic covering at the end of the handle similar to the plastic cover at the ends of motorcycle handle bars. This has no purpose other than for comfort and beauty.

In accordance with this embodiment, the locking pin is to contribute to the stabilization of the palette when positioned. It is a metal on the handle which is slid into a hole making one locking mechanism set which then goes into another hole in the base structure thereby locking the whole palette securely onto the structure base.

The other palette is composed of an axle rod which holds it in place to the base of the bed. On each end of the axle rod are two grooves wherein one is positioned beside the handle end and the other at the other end. To ensure the permanent stable position of the axle rod to the base structure of the bed, there are 2 curved pins in place inside the grooves. The axle rod is firmly set into the grooves. This palette has approximately six rods each having one end attached to the axle rod attached to the bed structure base while the other end is free to enable the sliding in of a plank. On each rod end are 3 holes angled equally (120 degrees) to each other to which a metal ball bearing assembly positioned on the hole of a plank is set to ensure the stable positioning of the plank on the rod and to prevent unwanted movements. On each rod of this particular palette, which is one of the two, what is different from the other is that at the end side attached to the axle rod, there is a curvature which is an essential part of the design to ensure that this particular palette does not touch against the other palette. The handle end of the rod is attached to the axle rod for easy and convenient manual rotating work. At the end of this handle is a hole to which a locking pin is positioned. Likewise, there is a plastic covering at the end of the handle similar to the plastic cover at the ends of motorcycle handle bars. This has no purpose other than for comfort and beauty. The locking pin is to contribute to the stabilization of the palette when positioned. It is a metal on the handle which is slid into a hole making one locking mechanism set which then goes into another hole in the base structure thereby locking the whole palette securely onto the structure base.

The planks which have been mentioned can either be rectangular 2-dimensional planks or triangular 3-dimensional planks which when placed in an inter-digital manner in a series become 1 palette. Each plank, this composite unit of the two palettes as mentioned has a center which goes through the whole length of the plank and would be useful in enabling the plank to rotate. The planks are each slid into a corresponding rod as mentioned above which has been attached permanently to the side of the bed structure. Each plank can be made of any solid durable material, whether wood, aluminum or any other suitable material, and each has a hole which is the rotating center and through which the planks are put together to make one palette. To ensure that each plank does not move loosely or shake or cause the turning of the palette thereby leading to the off balance of the patient, a ball bearing assembly has been put in place wherein a round metal ball is attached to a spring and both are positioned inside a hole which is again positioned over another hole in the plank. A groove is made on the hole to keep a curved metal firmly in place. Another groove keeps the metal ball in place. A hole at the end of each rod mentioned above is for the purpose of putting the metal ball bearing assembly in place. Also, this mechanism will enable the palette to stay firm when in one position and not to move unnecessarily.

Another aspect of the planks is that each has a soft permanent cover, preferably made of foam but may be made of any other suitable soft sponge-like material, which goes around each plank and also around the plank is a removable changeable bed sheet to keep clean the permanent cover. Through the rotation of each plank this sheet is likewise rotated thus ensuring that a clean side is always under the patient's back. If the plank is 2-dimensional there would be 2 sheet changes and if 3-dimensional there would be 3 sheet changes after which each fitted sheet is slid out and a clean one put in place. All the planks would be similar in all the four palettes of the two beds.

Another aspect of the invention is that although it is mentioned that the planks are made of strong, hard and durable material, an alternative would be that instead of using planks as the composite units of the palettes, plastic sacs can be used which can then be filled with air like a balloon to be pressurized as desired. Pressure can be regulated as desired and this mechanism would not only be useful for the prevention of bed sores in a patient but would also serve the same purpose as claimed above to transfer and transport patients.

It must be reiterated that the system as described is manual. However, the device can easily be altered in such a way that it can be operated electrically, hydraulically, pneumatically, and etc.

To transfer and transport a patient, the maneuverable bed is positioned beside the stable bed where the patient lies then the palettes of the maneuverable bed are turned 90 degrees downwards to the side of the bed after which one palette of the stable bed is cranked 90 degrees downwards thereby creating spaces to which the planks of one palette of the maneuverable bed can fill. The maneuverable bed is then slid into the stable bed and a palette raised 90 degrees upwards to fill up the empty spaces. Next, a palette of the stable bed is cranked downwards then the other palette of the maneuverable bed raised to fill the empty spaces. The patient is now completely transferred onto the maneuverable bed, ready to be transported. Finally, the maneuverable bed is separated from the stable bed.

Still another aspect of the invention is a further beneficial use in that each plank as mentioned above can be separately fitted with separate linen. This gives convenience when changing bed linen without the necessity of lifting the patient or moving the patient even slightly. Palettes can be interchangeably lowered downwards or to the sides away from the patient's back and have their fitted sheets changed. The planks can be rotated periodically to ensure that a clean side is always under the patient.

It is of further benefit that this invention makes it possible to accommodate the free passage of air flow under the patient's back to prevent the development of bed sores in continuously-prone and critically-ill patients. The palettes can be interchangeably lowered downwards or to the sides away from the patient's back in timed intervals to ensure that the patient's back is uniformly opened to the free flow of air. This is also very important for critically-burned patients.

### BRIEF DESCRIPTION OF THE DRAWINGS

To completely appreciate this invention and its uses thereof, figures are presented which in brief are:

FIG. 1 is a cross-sectional view of a three-dimensional triangular plank which is the composite unit of the palettes making up the bed.

FIG. 2 shows a schematic view of a palette and a cross-sectional view of the metal ball bearing assembly.

FIG. 3 is a schematic view of the base structure of the stable bed and also gives a closer view of the holes to which the palettes are positioned into the structure.

FIG. 4 gives an illustration of the rods attached to a main axle rod in the base structure and the locking mechanisms in place.

FIG. 5 is a schematic view of one of the two palettes in the bed and the locking mechanisms involved.

FIG. 6 is a perspective of the base structure of the maneuverable bed and shows the holes in place used to position the palettes.

FIG. 7 is a perspective of how the maneuverable bed is positioned with the stable bed to commence the transfer of the patient from the stable bed onto the maneuverable bed.

FIG. 8 shows the palettes of the maneuverable bed lowered 90 degrees downwards and to the sides of the bed.

FIG. 9 illustrates the lowering down and to the sides of palette 16 of the stable bed thereby creating empty spaces under the patient.

FIG. 10 is a perspective of how the maneuverable bed is slid into the stable bed.

FIG. 11 shows palette 29 of the maneuverable bed raised upwards to fill the empty spaces created by the lowering downwards of palette 16 of the stable bed.

FIG. 12 is a perspective of palette 29 of the stable bed lowered downwards.

FIG. 13 shows palette 16 of the maneuverable bed filling up the spaces emptied by the lowering down of palette 29 of the stable bed with the patient now completely transferred onto the maneuverable bed.

FIG. 14 shows the maneuverable bed being separated from the stable bed.

### DETAILED DESCRIPTION OF THE EMBODIMENTS

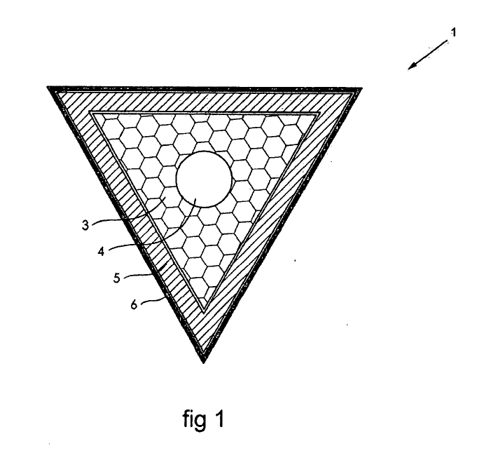

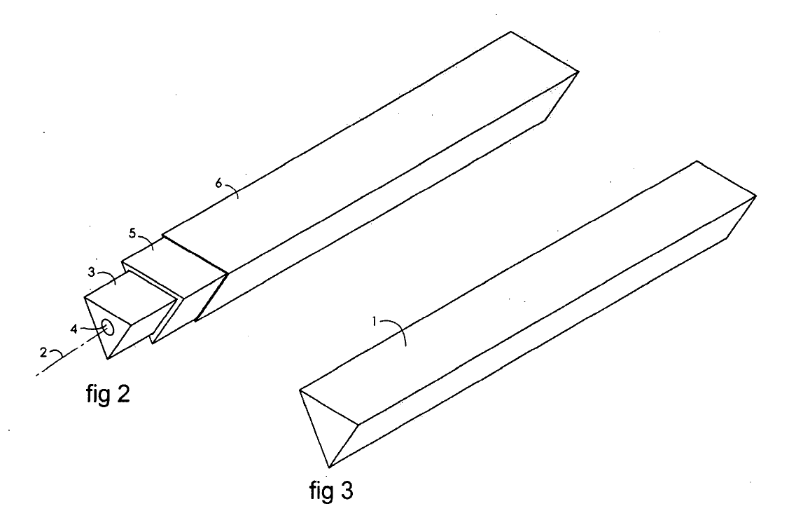

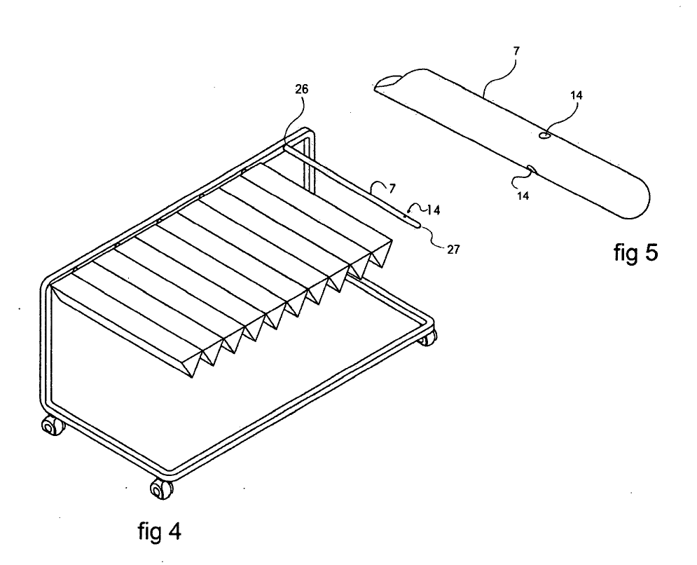

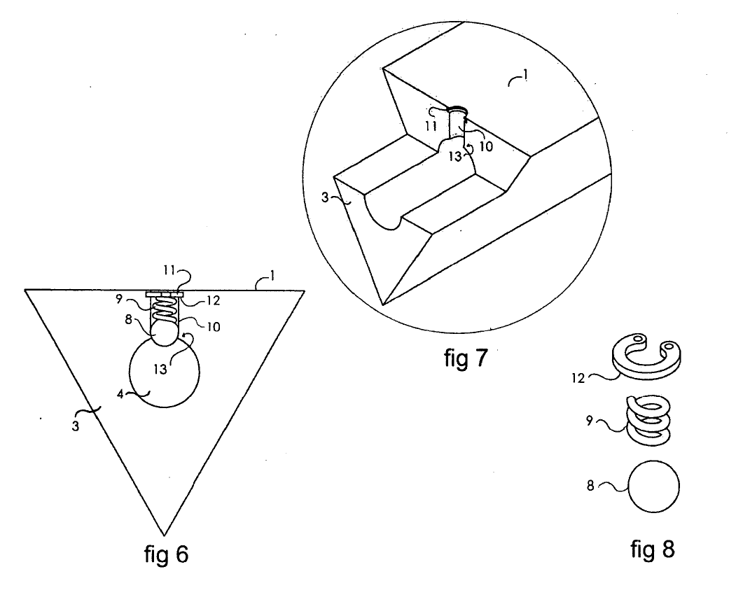

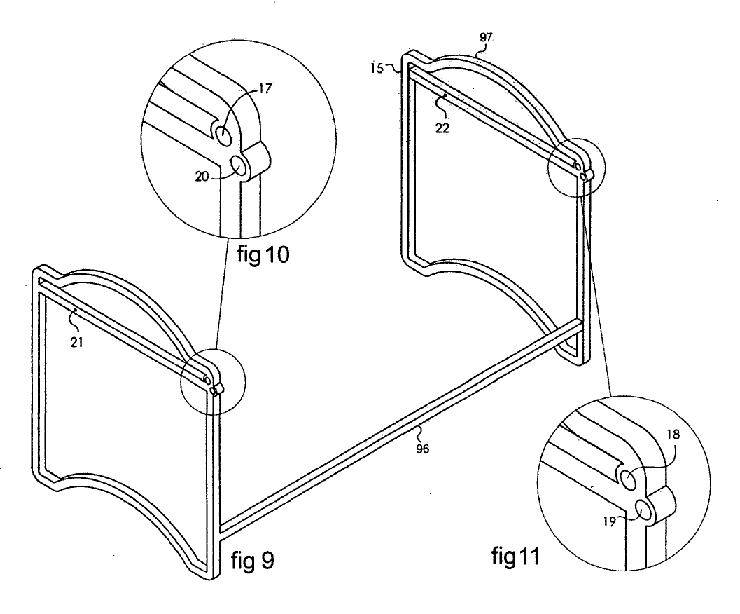

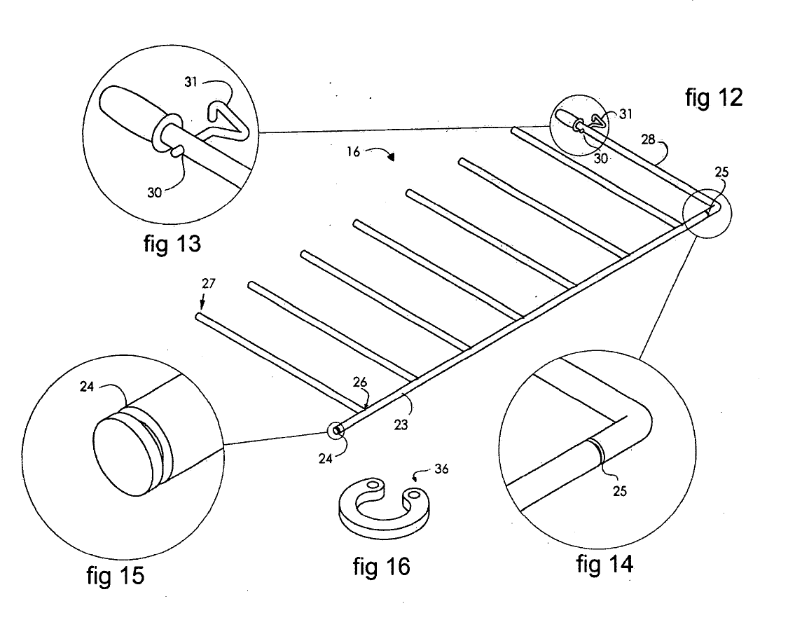

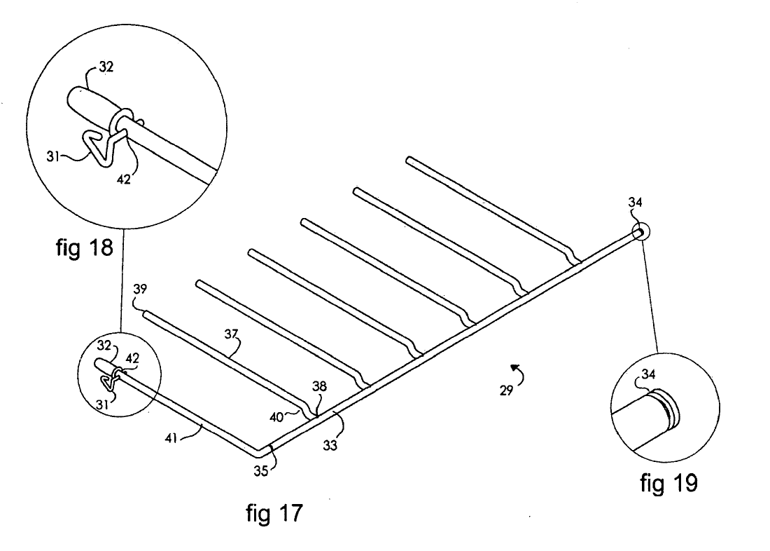

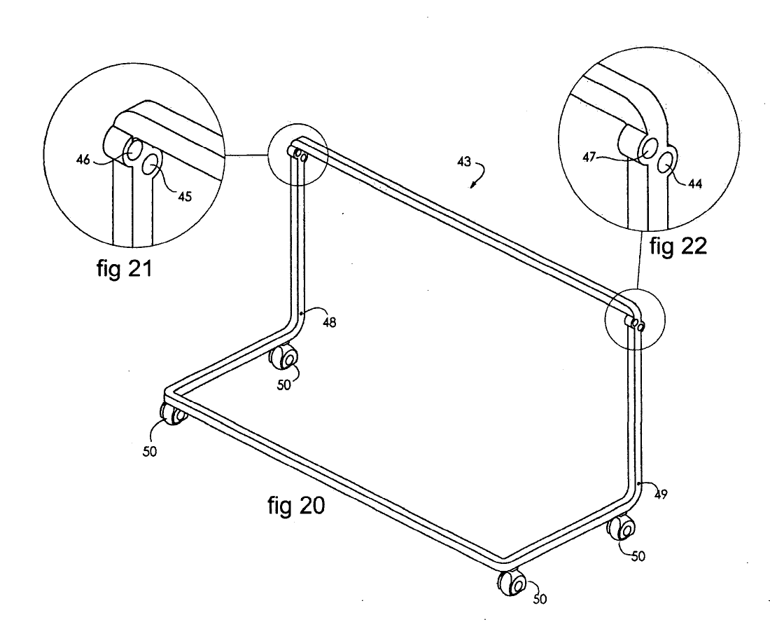

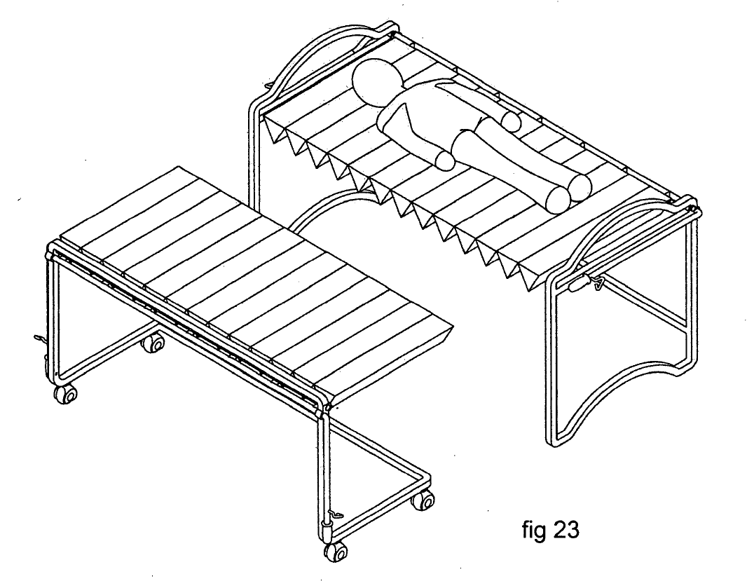

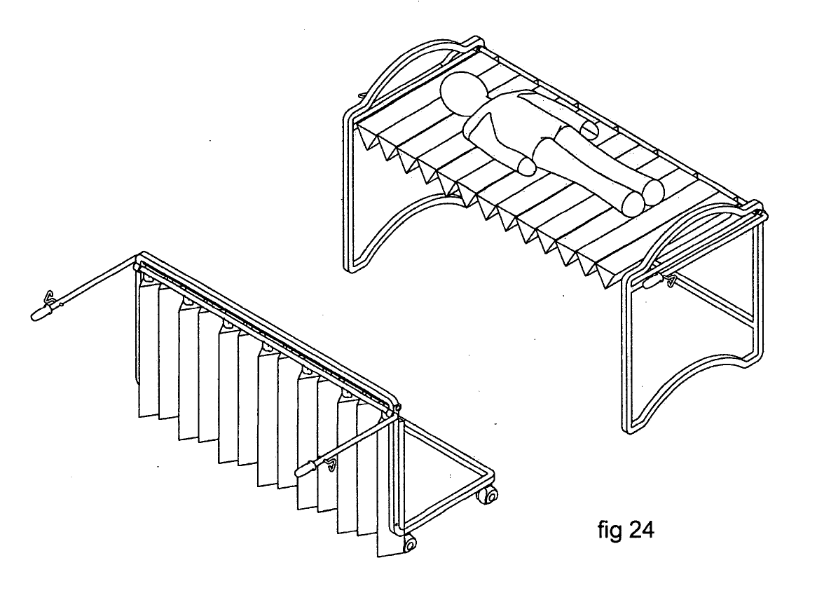

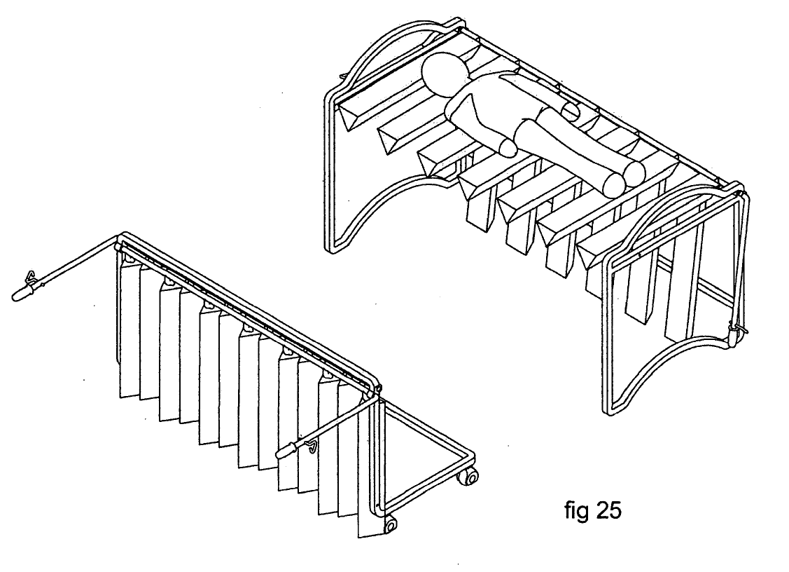

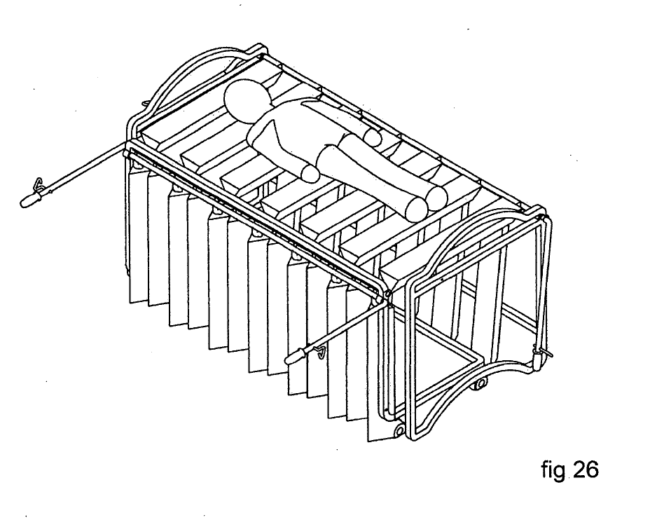

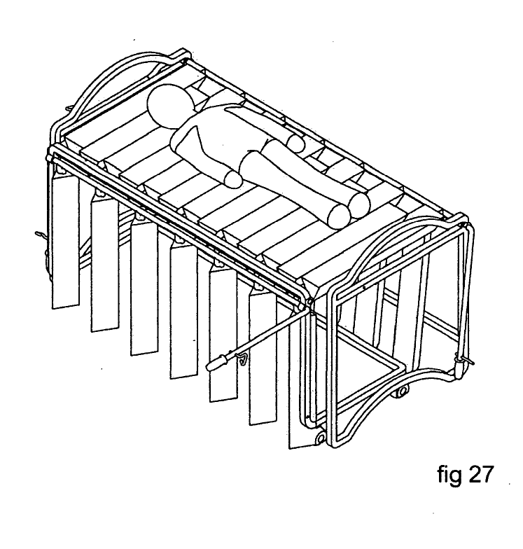

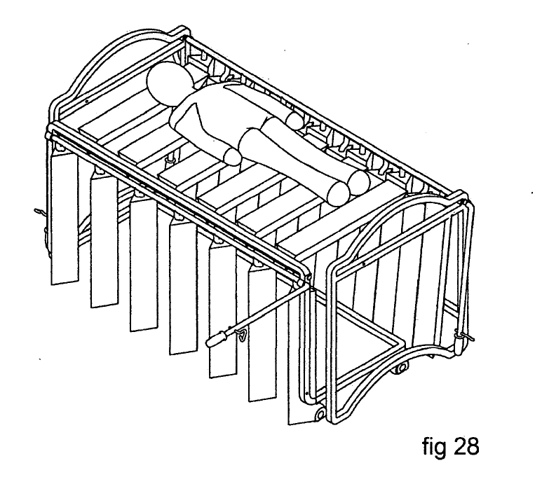

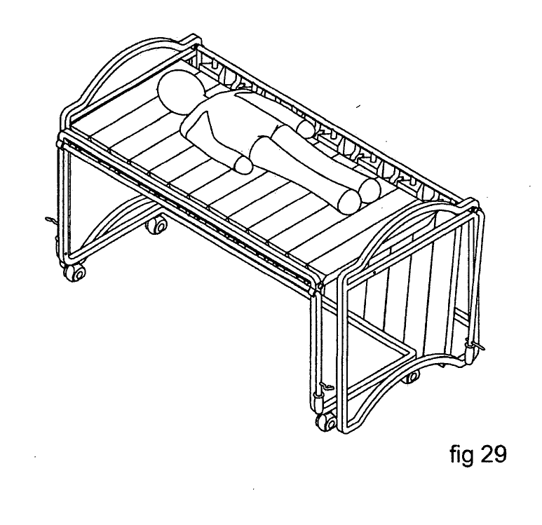

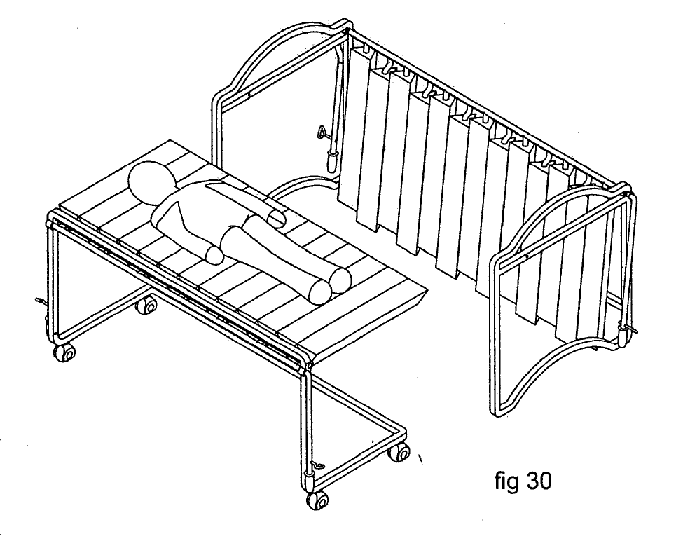

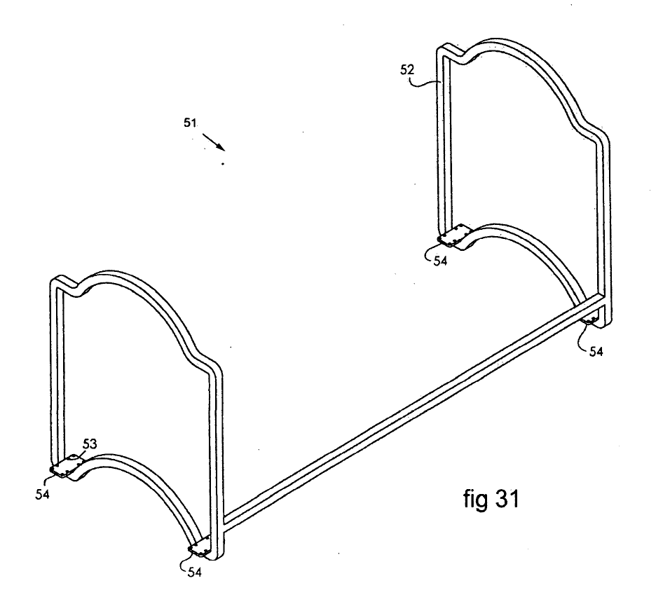

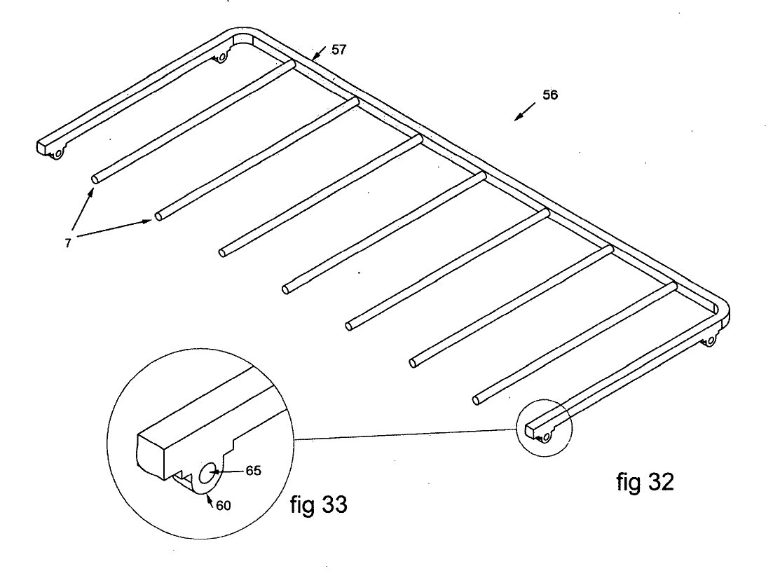

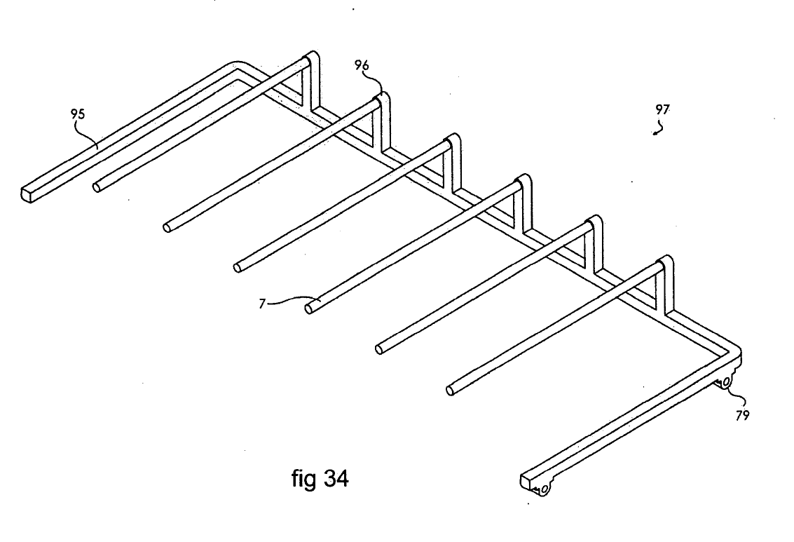

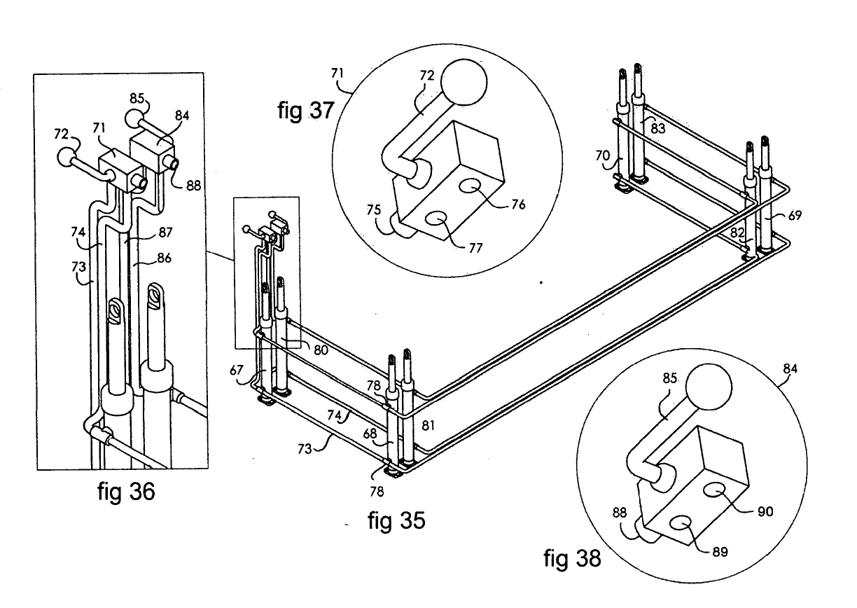

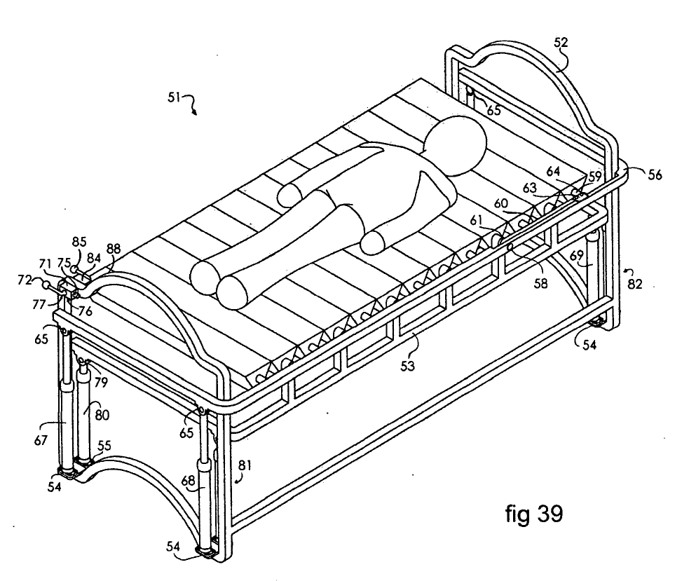

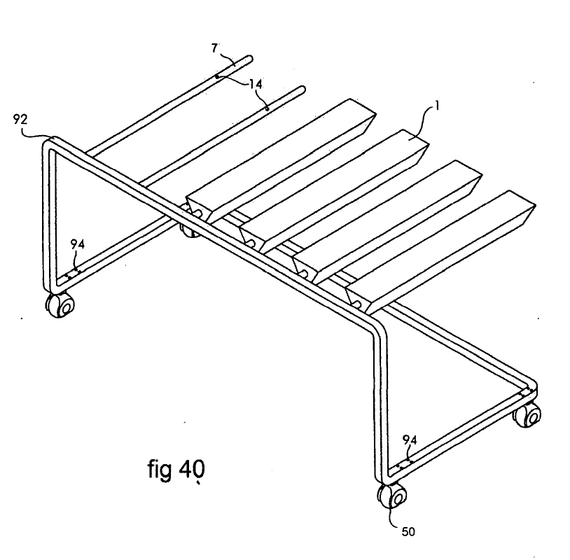

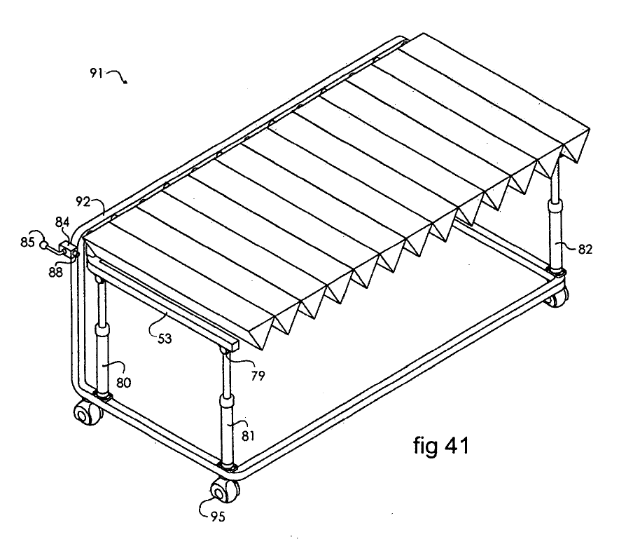

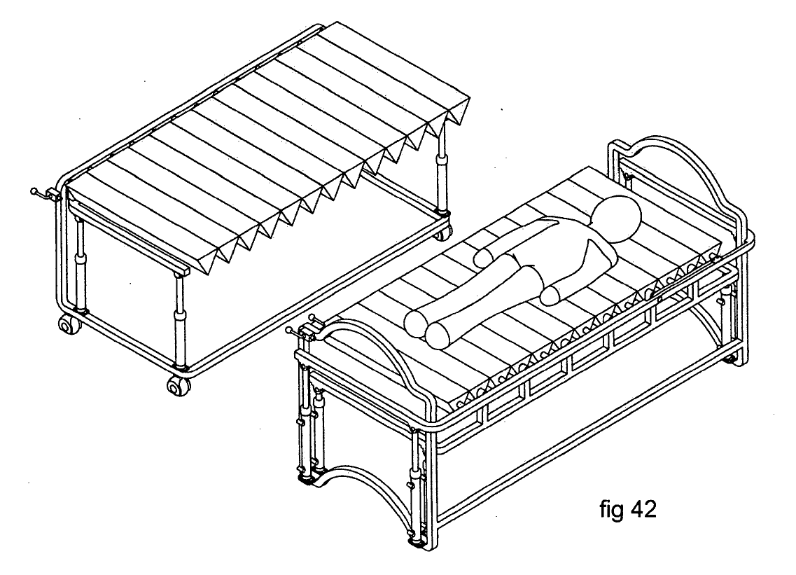

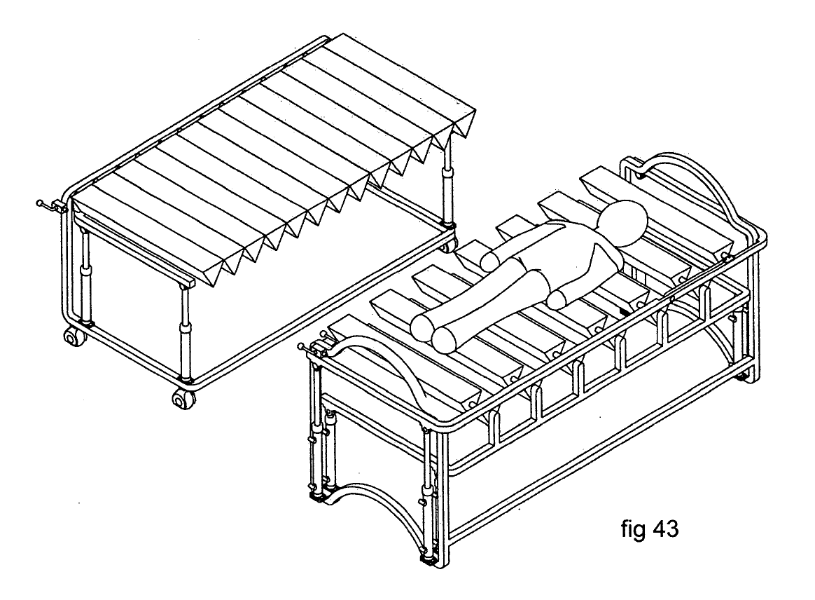

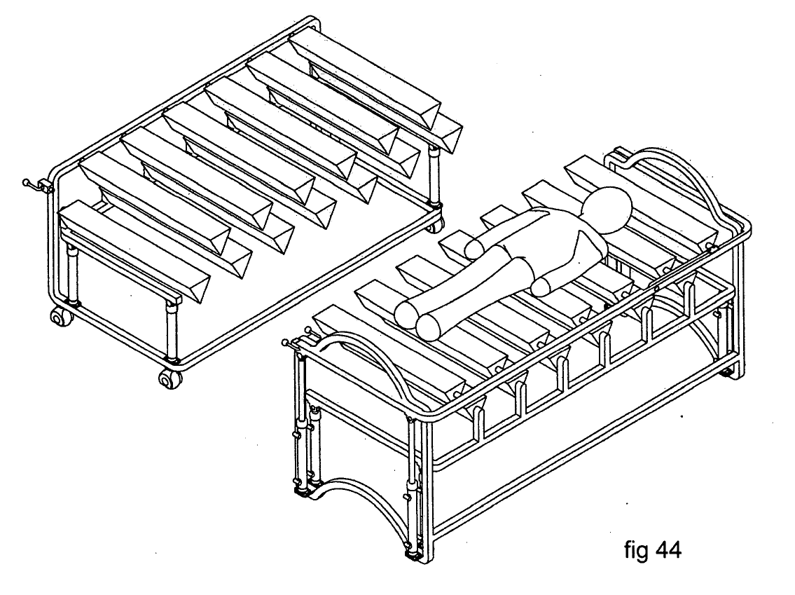

A detailed description of the embodiments herein commences with reference to FIGS. 1 to 6. There is shown 1 which is a triangular 3-dimensional plank which when placed in an inter-digital position in a series becomes 1 palette. It must be mentioned here that this plank, this composite unit of the palette, do not have to be only 3-dimensional. It can also be a 2-dimensional rectangle. Each plank has a center 2 which goes through the whole length of the plank and would be useful in enabling the plank to rotate. The planks are each slid into a corresponding rod 7 and each of these rods has been attached permanently to the side of the bed 23.

Each plank can be made of any solid durable material, whether wood, aluminum or any other suitable material, and each has a hole 4 which is the rotating center and through which the planks are put together to make one palette. To ensure that each plank does not move loosely or shake or cause the turning of the palette thereby leading to the off balance of the patient, a ball bearing assembly has been put in place wherein a round metal ball 8 is attached to a spring 9 and both are positioned inside a hole 10 which is again positioned over hole 4 in the plank. A groove is made on hole 10 to keep a curved metal 12 in place firmly. Another groove 13 keeps the metal ball in place.

Hole 14 at the end of each rod 7 is for the purpose of puffing the metal ball bearing assembly in place. Also, this mechanism will enable the palette to stay firm when in one position and not to move unnecessarily.

Each plank has a soft permanent cover 5, preferably made of foam but may be made of any other suitable soft sponge-like material, which goes around each plank. (An alternative would be that instead of using planks as the composite units of the palettes, plastic sacs can be used which can then be filled with air like a balloon to be pressurized as desired. Pressure can be regulated as desired and this mechanism would be useful for the prevention of bed sores in a patient.)

Also around the plank is a removable changeable bed sheet 6 to keep clean permanent cover 5 and through the rotation of each plank this sheet 6 is likewise rotated thus ensuring that a clean side is always under the patient's back. If the plank is 2-dimensional there would be 2 sheet changes and if 3-dimensional there would be 3 sheet changes after which each fitted sheet is slid out and a clean one put in place.

All the planks would be similar in all the four palettes of the two beds.

These two hospital beds are of 2 kinds: one stable and the other maneuverable for the transport of the patient. Both beds in this invention are operated manually but it should be noted that accessories like motors, gears, air and oil jacks, etc., can be added to change the system from being manual to being pneumatic, hydraulic, electrical, or whatever.

(1) The Stable Bed

Upon the base of the bed rests a strong structure 15 which is made of any durable hard material. The head in each end of the bed has an arch 97 under which are connecting sections 96 running from one side of the structure to the other to make the structure more stable. They have holes 21 and 22 to which is positioned locking pin 31 which has been set on holes 30 and 42 in each opposite side. Each bed has 2 palettes 16 and 29, each composed of 2-dimensional rectangular or 3-dimensional triangular planks placed in an inter-digital manner (i.e. there is equal space between each plank). At the sides of the bed heads are holes 17 to which one end of palette 16 is attached and 18 to which the other end is attached. Holes 19 and 20 hold each end of palette 29.

Palette 16 is composed of: an axle rod 23 which holds palette 16 in place to the base of the bed. On each end of the axle rod are two grooves 24 and 25 wherein groove 25 is positioned beside the handle end and groove 24 at the other end. To ensure the permanent stable position of axle rod 23 in the base structure of the bed 15, there are 2 curved pins 36 in place inside grooves 24 and 25. Axle rod 23 is firmly set into grooves 24 and 25.

In palette 16 are approximately seven rods 7. Each rod 7 for each plank is a strong rod in which one end 26 is attached to axle rod 23 while the other end 27 is free to enable the sliding in of the plank. On each rod end 27, there are 3 holes angled equally (120 degrees) to each other to which the metal ball 8 bearing assembly on the hole of each plank is set to ensure the stable positioning of the plank on the rod and to prevent unwanted movements.

Handle end 28 is a rod attached to axle rod 23 for easy and convenient manual rotating work. At the end of this handle is hole 30 to which pin 31 is positioned inside. Likewise, there is a plastic covering 32 at the end of the handle similar to the plastic cover at the ends of motorcycle handle bars. This has no purpose other than for comfort and beauty.

With regards to pin 31, its purpose is to contribute to the stabilization of the palette when positioned. It is a metal on the handle which is slid into a hole 30 making one locking mechanism set which then goes into a hole 21 in the base structure thereby locking the whole palette onto the structure base 15.

Palette 29 is composed of: an axle rod 33 which holds palette 16 in place to the base of the bed. On each end of the axle rod are two grooves 34 and 35 wherein groove 35 is positioned beside the handle end and groove 34 at the other end. To ensure the permanent stable position of axle rod 33 in the base structure of the bed 15, there are 2 curved pins 36 in place inside grooves 34 and 35. Axle rod 33 is firmly set into grooves 34 and 35.

In palette 29 are approximately six rods 37. Each rod 37 for each plank is a strong rod in which one end 38 is attached to axle rod 33 while the other end 39 is free to enable the sliding in of the plank. On each rod end 39, there are 3 holes angled equally (120 degrees) to each other to which the metal ball 8 bearing assembly on the hole of each plank is set to ensure the stable positioning of the plank on the rod and to prevent unwanted movements.

On rod 37, at the end side attached to axle rod 33, there is a curvature 40 which is an essential part of the design to ensure that palette 16 does not touch against palette 29.

Handle end 41 is a rod attached to axle rod 33 for easy and convenient manual rotating work. At the end of this handle is hole 42 to which pin 31 is positioned inside. Likewise, there is a plastic covering 32 at the end of the handle similar to the plastic cover at the ends of motorcycle handle bars. This has no purpose other than for comfort and beauty.

With regards to pin 31, its purpose is to contribute to the stabilization of the palette when positioned. It is a metal on the handle which is slid into a hole 42 making one locking mechanism set which then goes into a hole 22 in the base structure thereby locking the whole palette onto the structure base 15.

(2) The Maneuverable Bed

Upon the base of the bed rests a strong structure 43 which is made of any durable hard material and has holes to keep the palettes in place: Hole 44 to position axle rod 23 in place and hole 45 to hold one end of palette 16; hole 46 keeps in place the head section of palette 29 and hole 47 is for its side handle; hole 48 facilitates the entry of pin 33 which is in the handle of palette 16 and hole 49 for pin 31 in the handle of palette 29.

This base has 4 wheels 50 attached to the base structure 43 to enable the transport and transfer of patients to another location in the medical establishment.

The palettes 16 and 29 of both stable and maneuverable beds are similar.

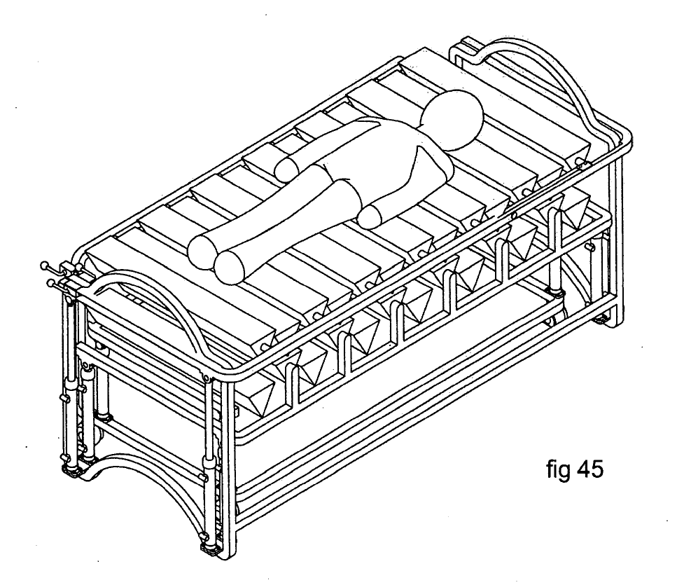

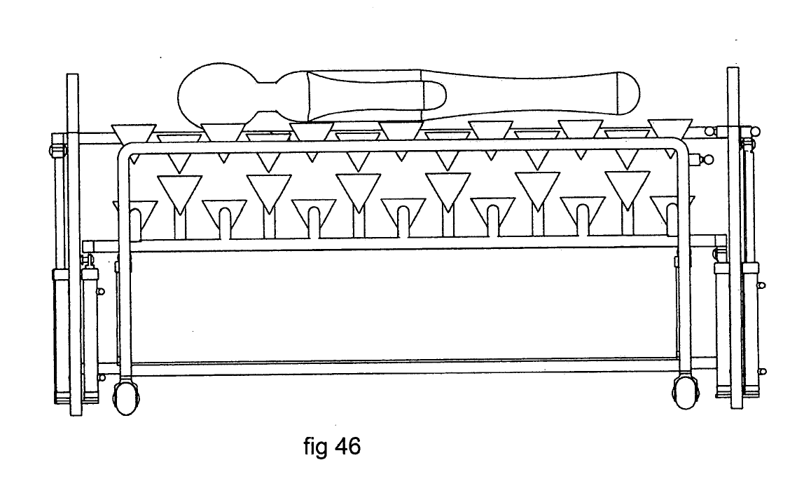

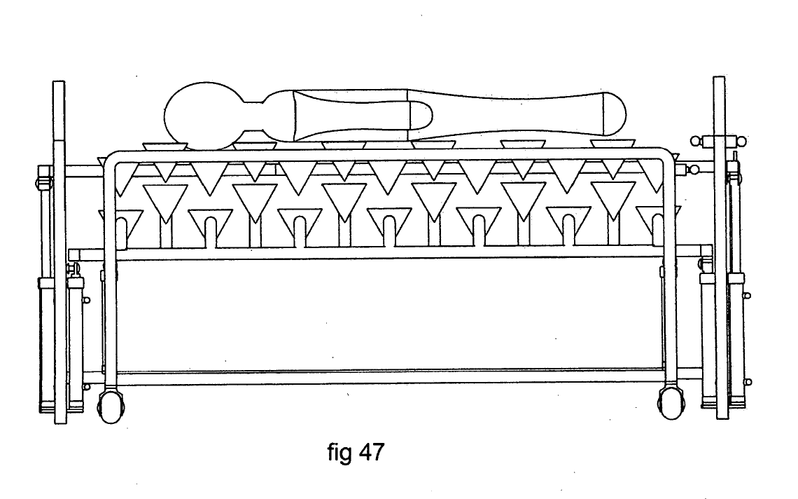

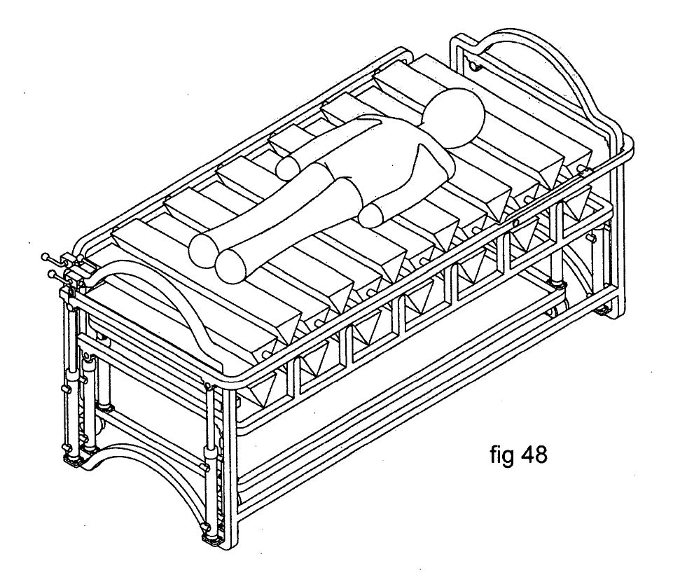

In FIG. 7, the maneuverable bed is positioned beside the stable bed where the patient lies.

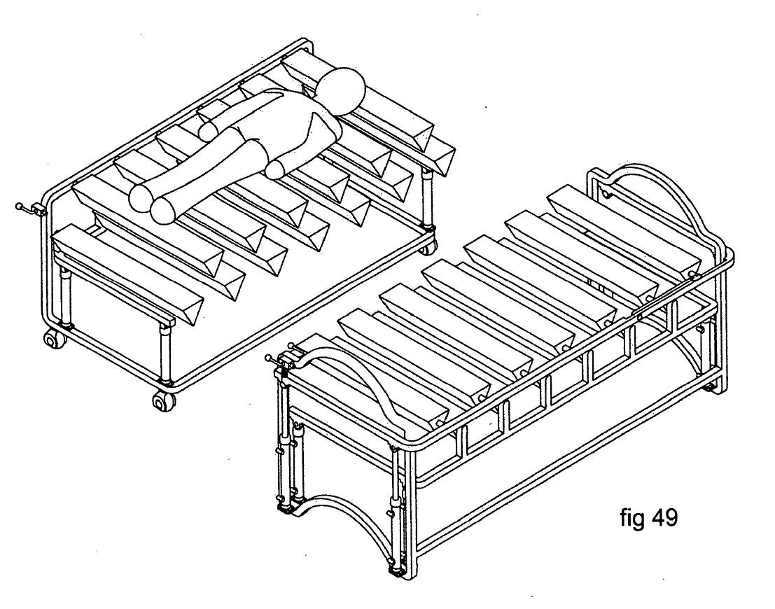

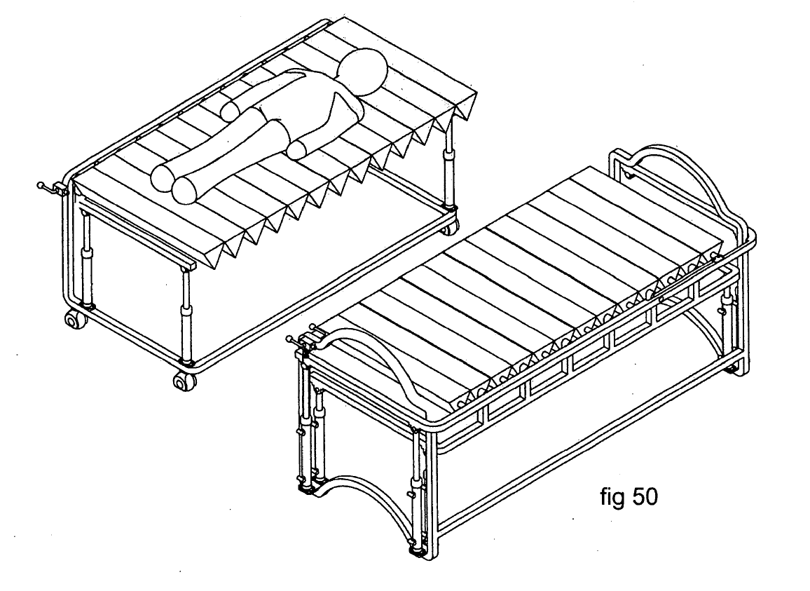

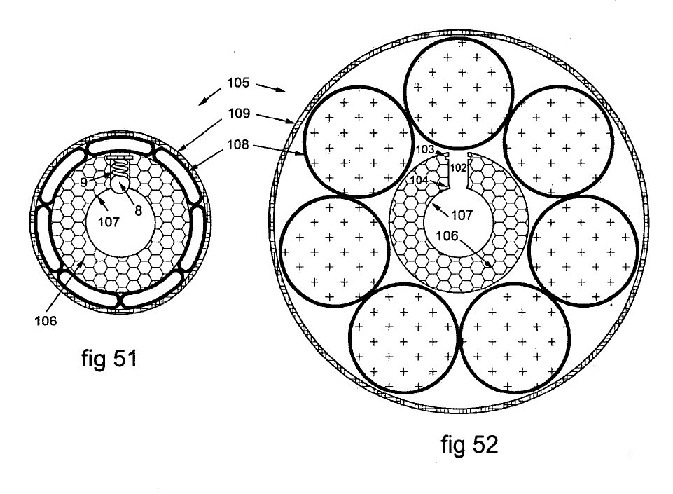

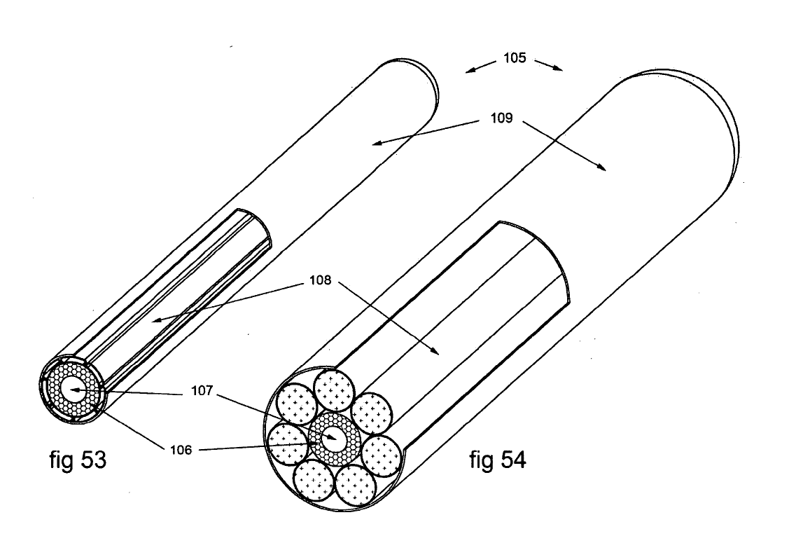

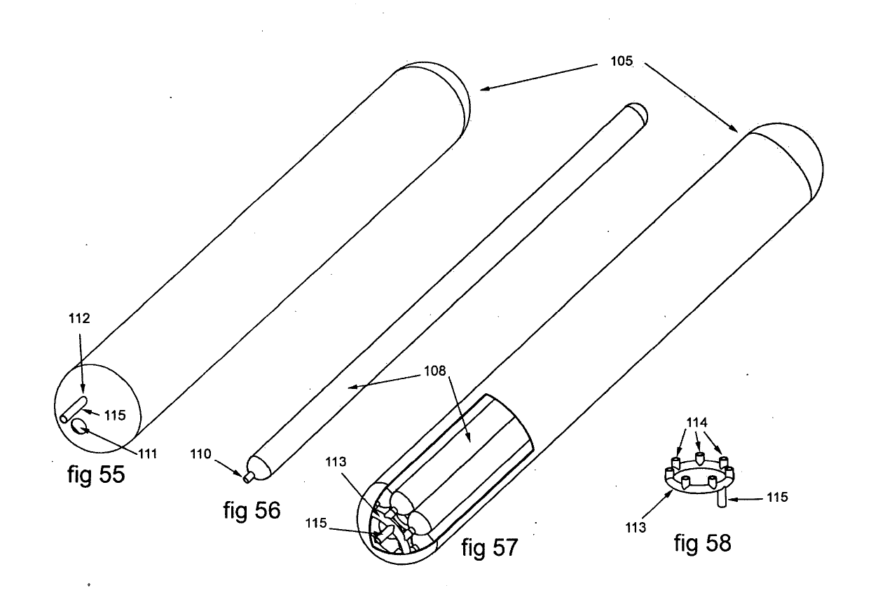

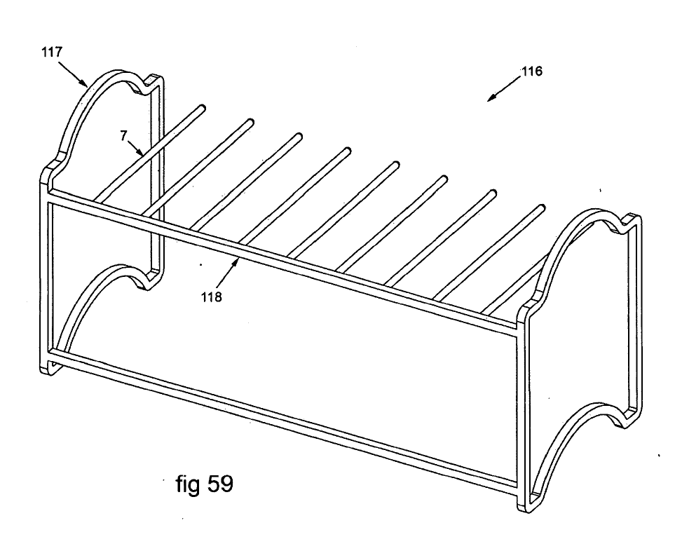

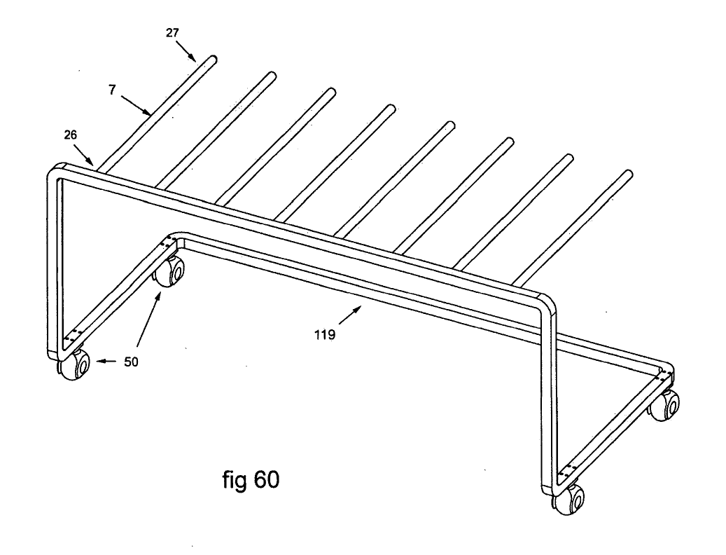

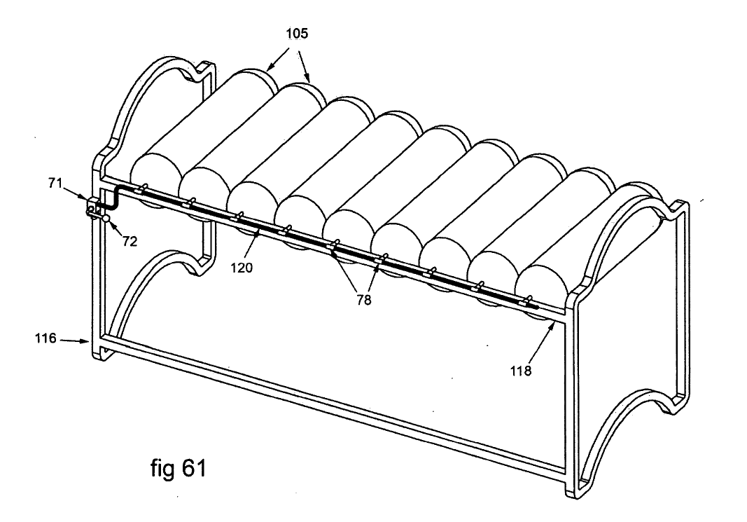

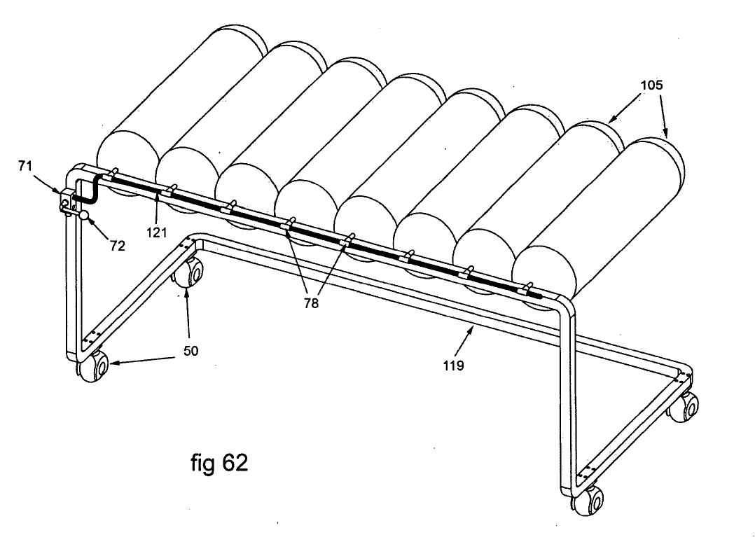

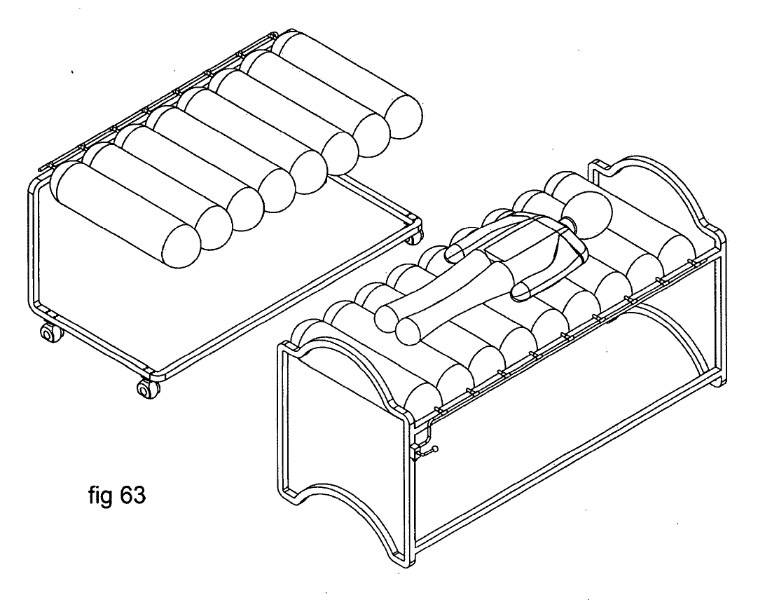

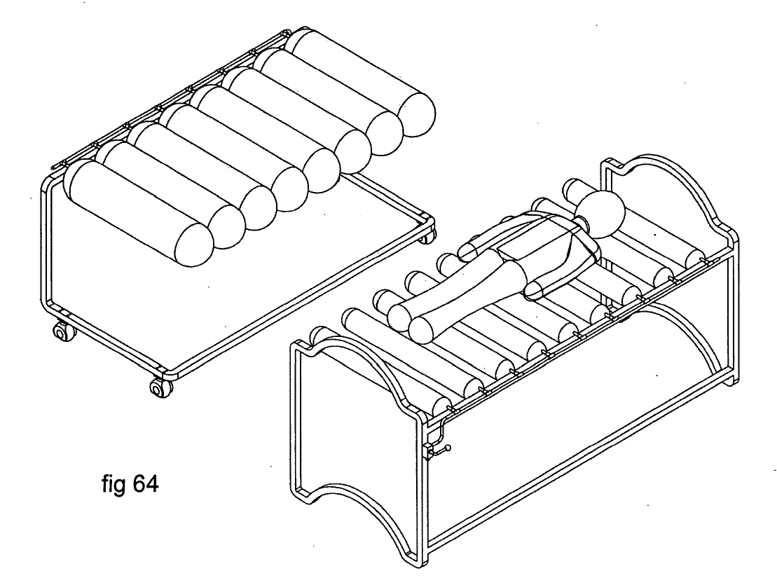

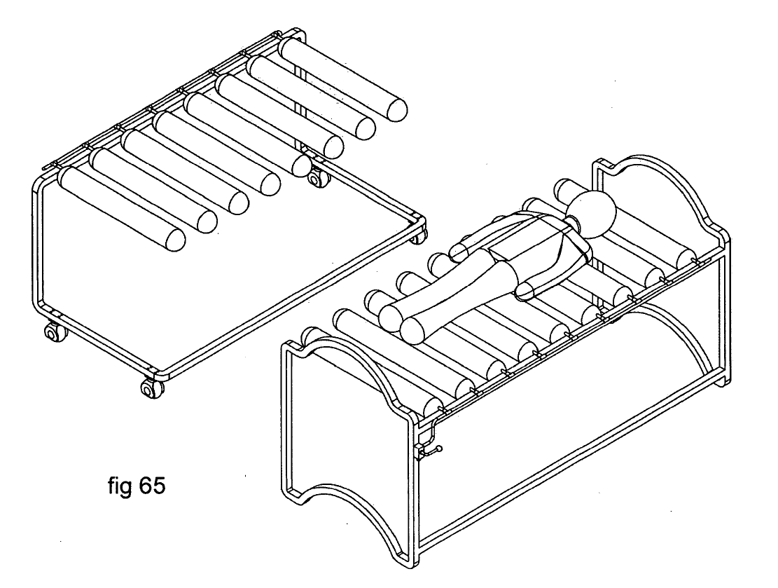

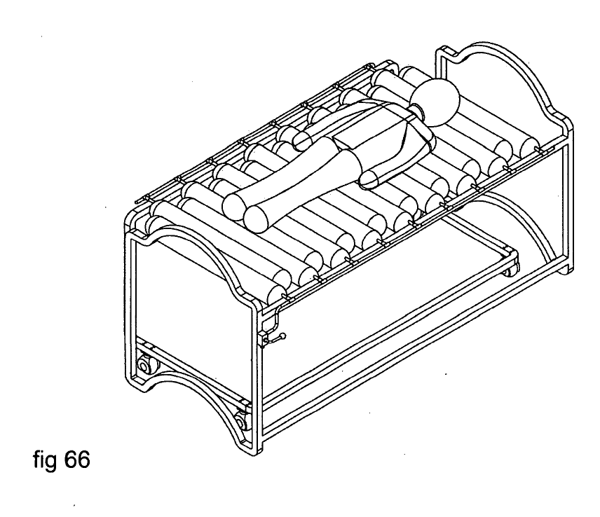

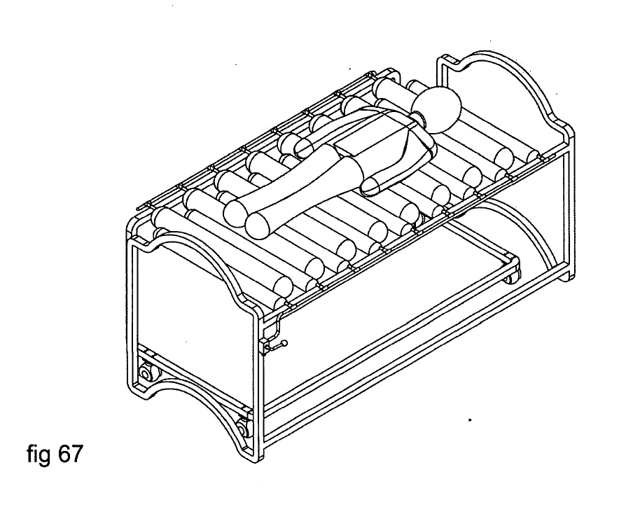

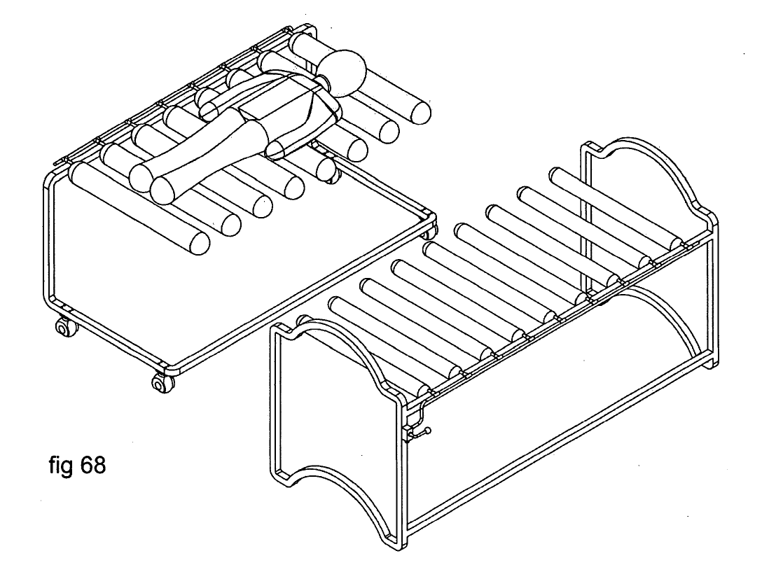

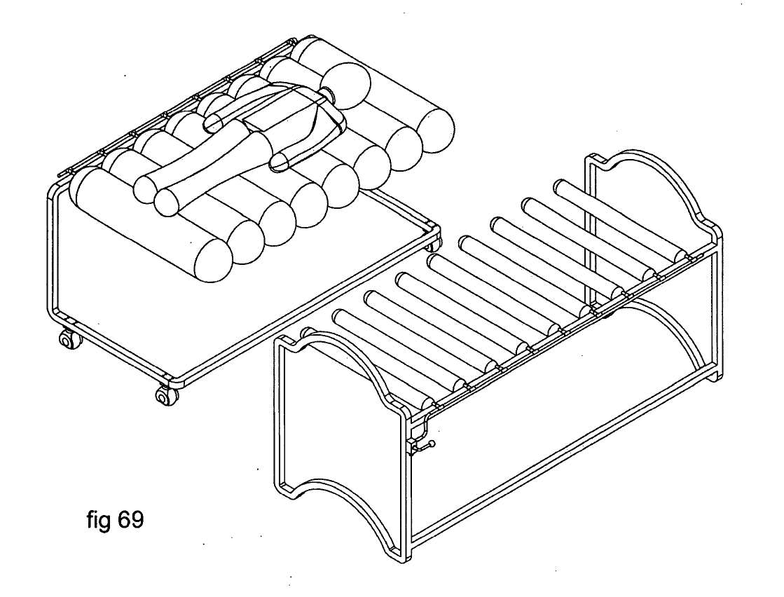

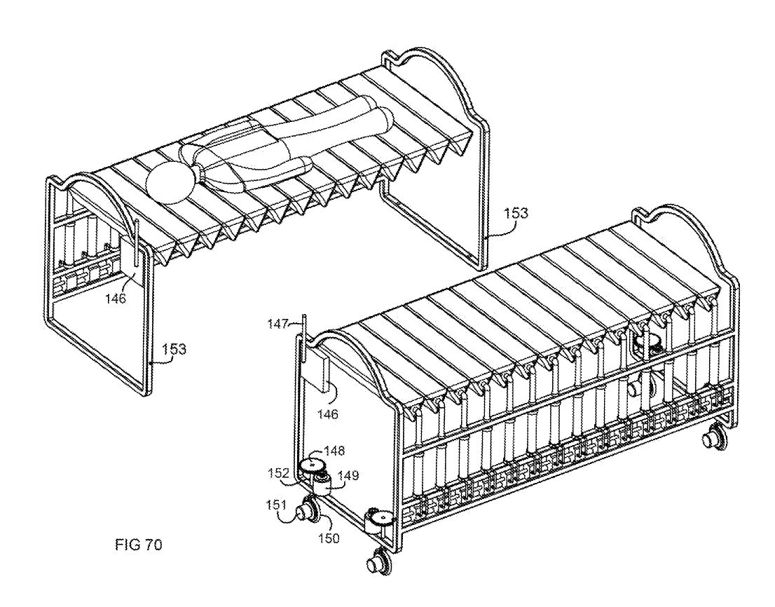

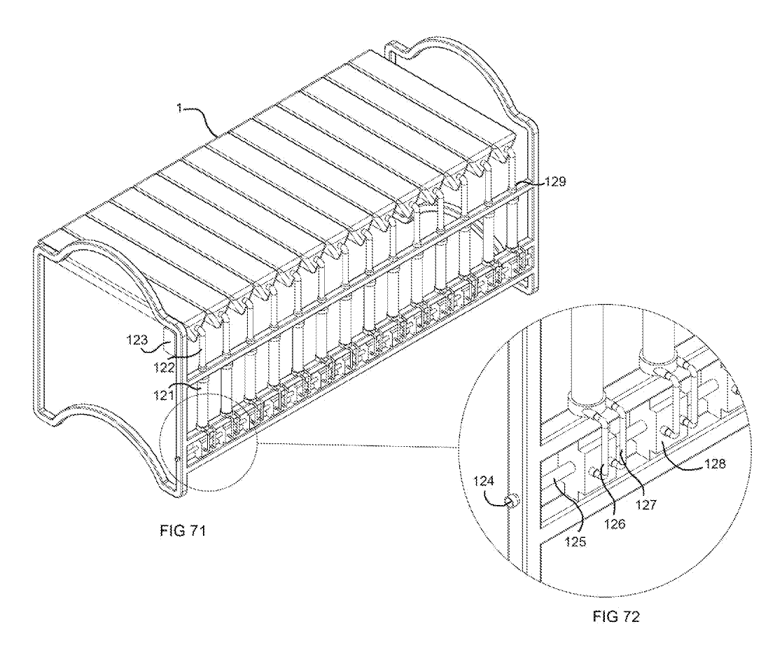

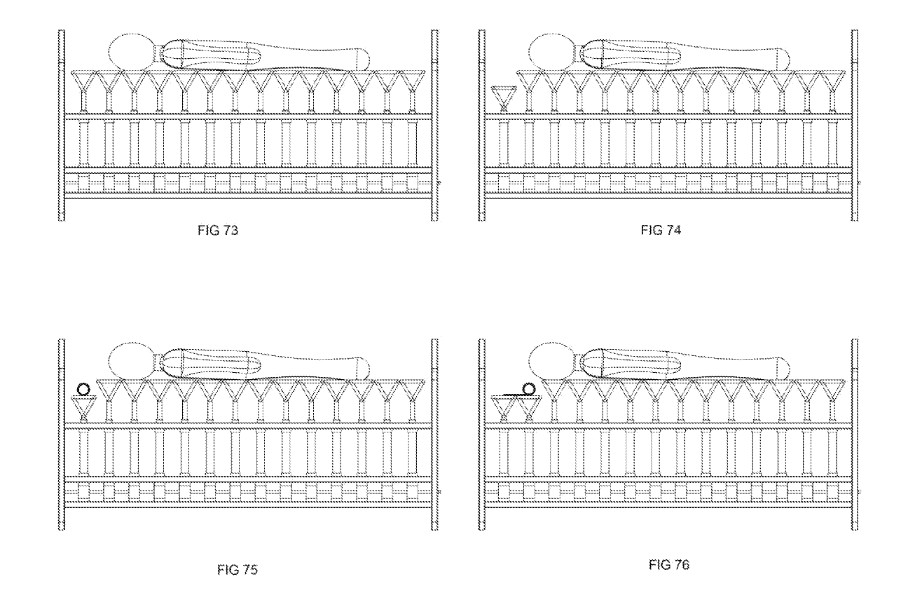

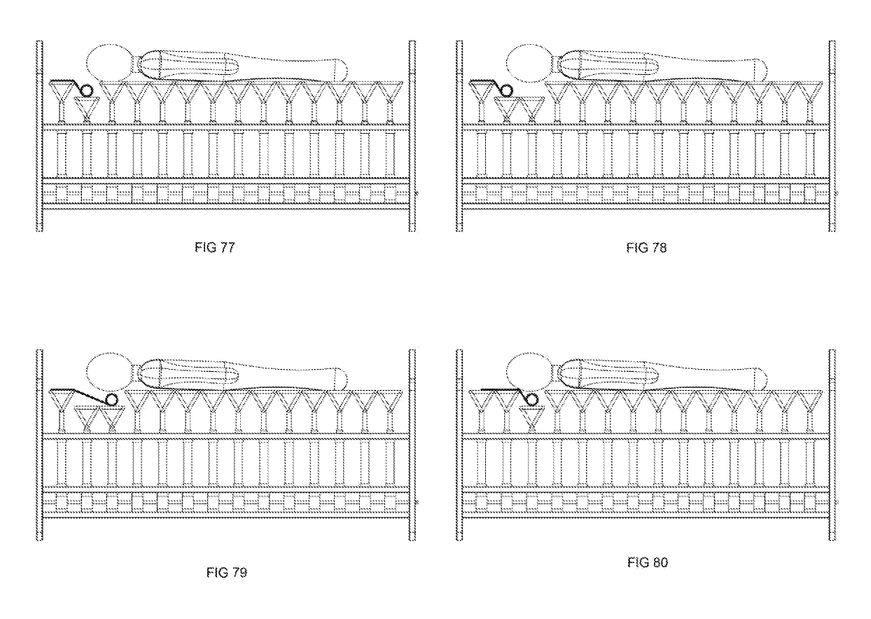

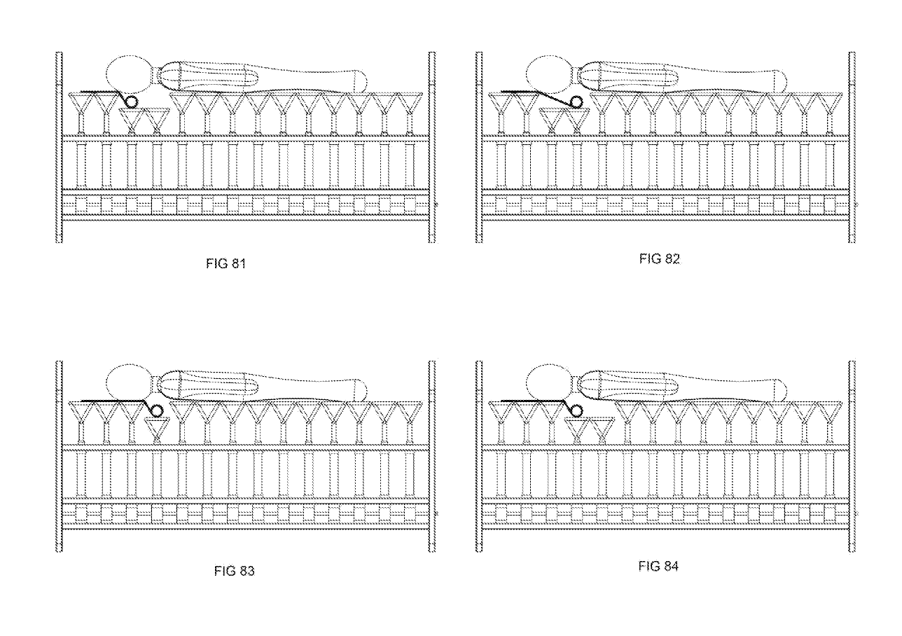

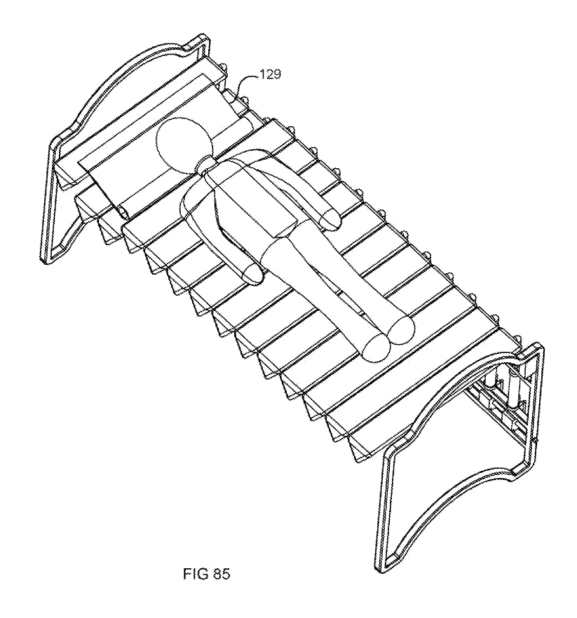

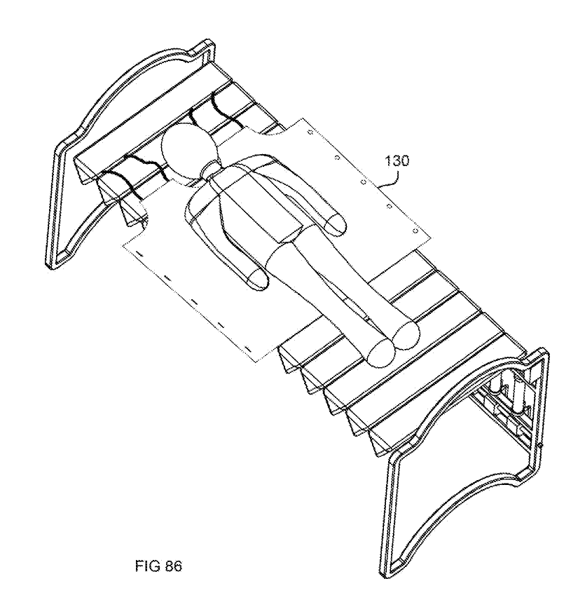

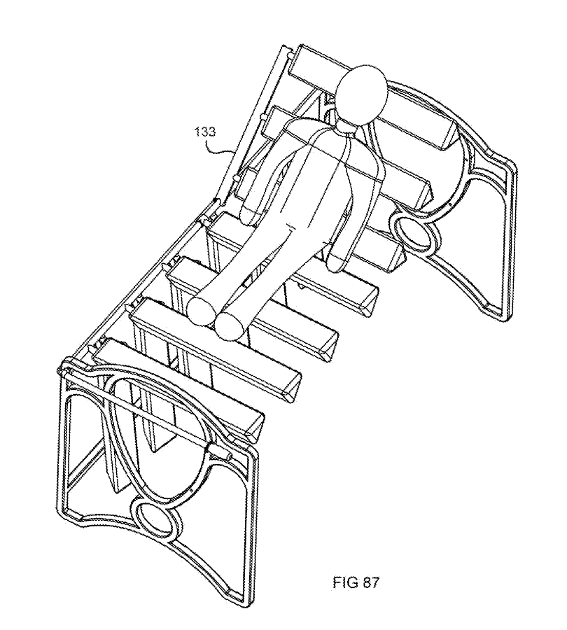

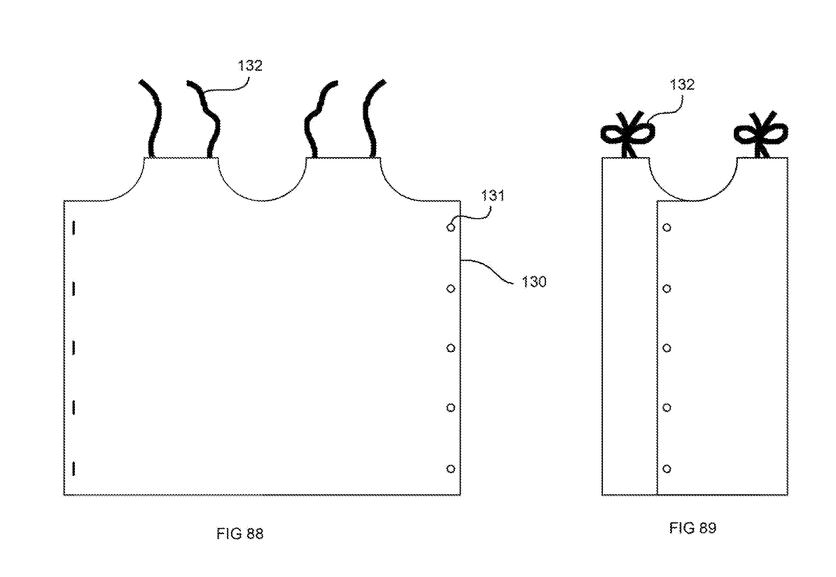

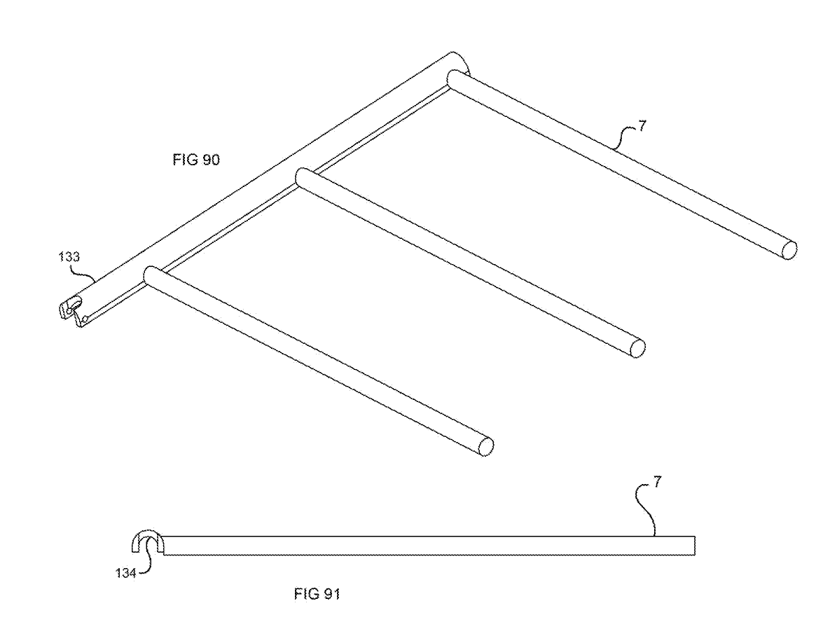

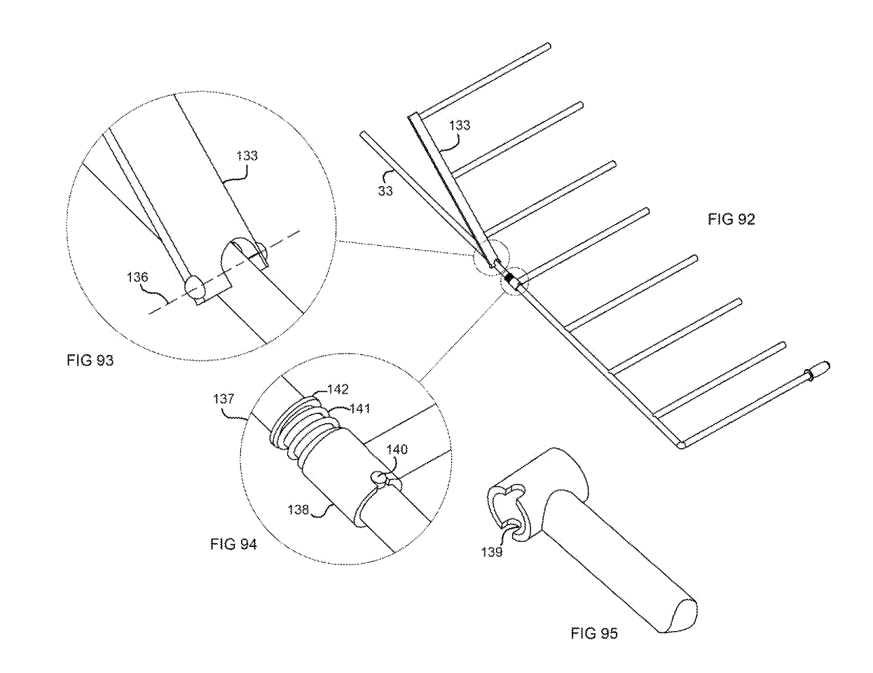

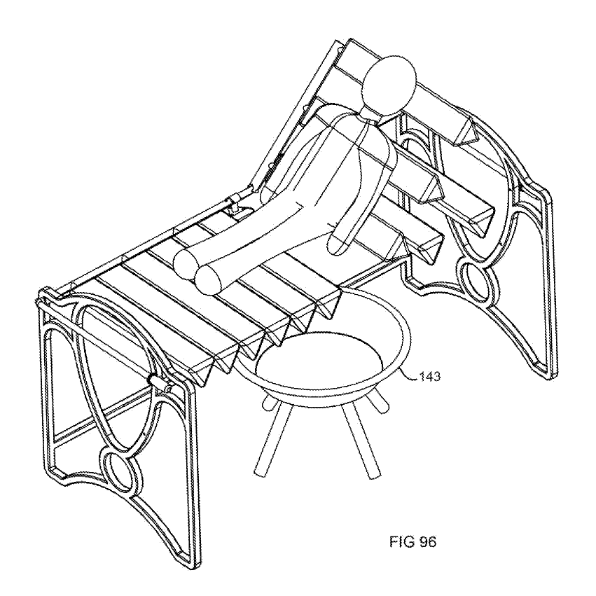

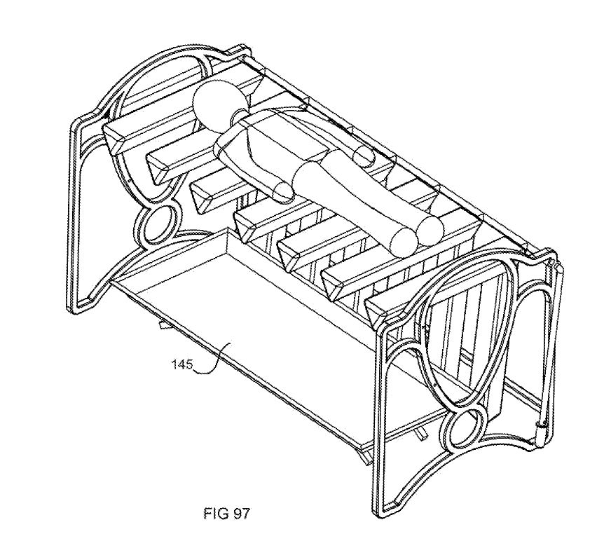

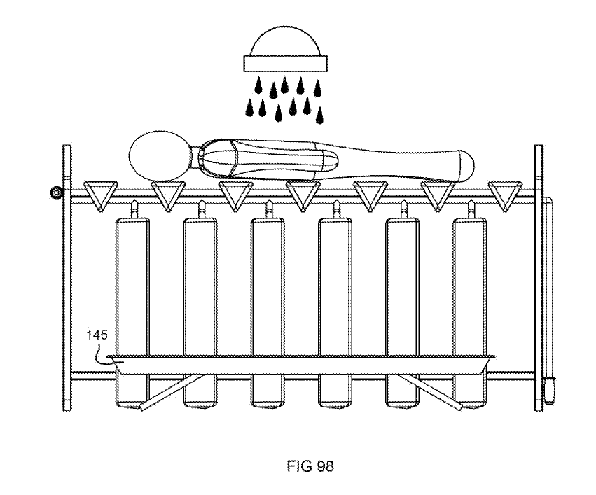

In FIG. 8, palettes 16 and 29 of the maneuverable bed are turned 90 degrees downwards to the side of the bed. In FIG. 9, palette 16 of the stable bed is cranked 90 degrees downwards creating spaces to which the planks of palette 29 of the maneuverable bed can fill. In FIG. 10 the maneuverable bed slides into the stable bed and in FIG. 11 its palette 29 is shown going up 90 degrees filling up the empty spaces. In FIG. 12, palette 29 of the stable bed is cranked downwards and in FIG. 13, palette 16 of the maneuverable bed is shown filling up the empty spaces. The patient is now completely transferred onto the maneuverable bed, ready to be transported. FIG. 14 shows the maneuverable bed being separated from the stable bed.

For emphasis, it must be reiterated that although this invention has been described with reference to particular embodiments, it is to be understood that these embodiments are merely illustrations of the principal applications of this present invention. Numerous modifications may be made especially as to materials used and to energy supplied if transformed from a manually-operated system to a system which is energy driven. However, other arrangements devised, many of which have been mentioned here, would not depart from the scope of this present invention.

What is claimed is:

1. A system for transferring a patient from one bed to another bed comprising:
a first bed having a plurality of predetermined sections wherein said first bed is moveable and comprises a surface for resting said patient;
a second bed having a plurality of predetermined sections wherein said second bed is moveable and comprises a surface for resting said patient;
a means for combining said surface of said first bed with said surface of said second bed by removing at least one of said plurality of predetermined sections of said surface of said first bed and replacing said at least one of said plurality of predetermined sections of said surface of said first bed with at least one of said plurality of predetermined sections of said surface of said second bed without requiring a movement from said patient and without causing any movement to a body of said patient and without lifting said patient;
wherein said pluralities of predetermined sections of said surface said first bed and said pluralities of predetermined sections of said surface of second bed have a center base provided with a central axial hole to receive a rod, a vertical hole connected to said central axial hole, a ball bearing assembly arranged in said vertical hole, a groove arranged over said vertical hole and a metal locking pin provided in said groove.

2. The system according to claim 1, further comprises:
a first axle rod and a second axle rod dedicate to said first bed;
a first plurality of rods wherein each of said first plurality of rods comprises a first end and a second end wherein said first end is attached to said first axle rod of said first bed;
a second plurality of rods wherein each of said second plurality of rods comprises a first end and a second end wherein said first end is attached to said second axle rod of said first bed.

3. The system according to claim 2, wherein a first plurality of predetermined sections of said first bed are attached to said first plurality of rods of said first bed and a second plurality of predetermined sections of said first bed are attached to said second plurality of rods of said first bed respectively.

4. The system according to claim 1, further comprises:
a first axle rod and a second axle rod dedicated to said second bed;
a first plurality of rods wherein each of said first plurality of rods comprises a first end and a second end wherein said first end is attached to said first axle rod of said second bed;
a second plurality of rods wherein each of said second plurality of rods comprises a first end and a second end wherein said first end is attached to said second axle rod of said second bed.

5. The system according to claim 4, wherein a first plurality of predetermined sections of said second bed are attached to said first plurality of rods of said second bed and a second plurality of predetermined sections of said second bed are attached to said second plurality of rods of said second bed respectively.

6. The system according to claim 1, wherein said system further comprises a means for lowering said plurality of predetermined sections.

7. The system according to claim 6, wherein said means is manual, pneumatic or mechanical.

8. The system according to claim 1, wherein said system further comprises a means for rotating said plurality of predetermined sections.

9. The system according to claim 8, wherein said means is manual, pneumatic or mechanical.

10. The system according to claim 1, wherein said system further comprises a means for rising said plurality of predetermined sections.

11. The system according to claim 10, wherein said means is manual, pneumatic or mechanical.

12. The system according to claim 1, wherein said system comprises a means for securing said base center to said rods.

13. The system according to claim 1, wherein both said first bed and said second bed comprises a first palette and a second palette wherein said first palette and said second palette of said first bed comprises said pluralities of predetermined sections of said surface said first bed and wherein said first palette and said second palette of said second bed comprises said pluralities of predetermined sections of said surface of second bed

14. The system according to claim 13, wherein said first palette and said second palette comprises a plurality of planks placed in an inter digital position so that said plurality of planks are separated by equal space.

15. The system according to claim 14, wherein each plank in said plurality of planks is a two dimensional plank.

16. The system according to claim 15, wherein said two dimensional plank is a rectangular plank.

17. The system according to claim 14, wherein each plank in said plurality of planks is a three dimensional plank.

18. The system according to claim 17, wherein the three dimensional plank is a triangular plank.

19. The system according to claim 14, wherein each said plank comprises a center base provided with the central axial hole which acts as a rotating center, a soft permanent cover arranged over said center base and a removable, changeable bed sheet arranged over said soft permanent cover.

20. The system according to claim 14, wherein each said plank is fitted with a separate bed sheet so that each said plank is rotated separately to provide a clean surface always under said patient.

21. The system according to claim 14, wherein each said plank is removable.

22. The system according to claim 13, wherein each said palette in said pluralities of palettes is moved interchangeably downwards to sides or straight down and away from said patient's back.

23. The system according to claim 13, wherein each said palette is attached with a handle to move each said palette downwards to sides or straight down and away from said patient's back.

24. The system according to claim 13, wherein said first palette and said second palette has an axle rod and pluralities of rods attached to said axle rod to hold and receive said pluralities of planks respectively.

25. The system according to claim 24, wherein said axle rod in said first palette and said axle rod in said second palette has two grooves provided respectively at two distal ends to receive and accommodate a respective curved pin to ensure a permanent stable position of said axle rod in said first bed or said second bed.

26. The system according to claim 24, wherein each said rod in the pluralities of said rods is received into said hole in said base center in each said plank to hold each said plank with each of said first palette and said second palette and to rotate each said plank.

27. The system according to claim 24, wherein each said rod has three holes positioned at equal distances to each other to receive the ball bearing assembly to ensure a stable positioning of each said plank on each said rod to prevent unwanted movements.

28. The system according to claim 24, wherein each of said pluralities of rods in said second palette in said first bed or second bed has a curvature.

29. The system according to claim 1, wherein both said first bed and said second bed has a base mounted with a strong rigid frame at two opposite sides.

30. The system according to claim 30, wherein said strong rigid frame has a hole to receive a locking pin which serves as a locking mechanism to clamp a handle with said strong rigid frame and to keep each said palette in place.

31. The system according to claim 30, wherein the strong rigid frame has another two holes to receive and support said first palette and said second palette respectively in said first bed or said second bed.

32. The system according to claim 30, wherein said two another holes are arranged one above another to receive said axle rod of said first palette and said second palette respectively so that one of said first palette and said second palette is positioned above another.

33. The system according to claim 24, wherein said handle is attached to one end of said axle rod which is attached to said base of said first bed or said second bed to manually rotate each said first palette and said second palette.

34. The system according to claim 24, wherein said handle is provided with a hole at one end to receive the locking pin to lock said handle with said strong rigid frame in said base of said first bed or said second bed.

35. A system for transferring a patient from one bed to another bed comprising:
a first bed having a plurality of predetermined sections wherein said first bed is stationary and comprises a surface for resting said patient;
a second bed having a plurality of predetermined sections wherein said second bed is moveable and comprises a surface for resting said patient;
a means for combining said surface of said first bed with said surface of said second bed by removing at least one of said plurality of predetermined sections of said surface of said first bed and replacing said at least one of said plurality of predetermined sections of said surface of said first bed with at least one of said plurality of predetermined sections of said surface of said second bed without requiring a movement from said patient and without causing any movement to a body of said patient and without lifting said patient.

36. The system according to claim 35, wherein said surface of said first bed is combined with said surface of said second bed by vertically moving down at least one of said plurality of predetermined sections of said surface of said first bed and at least one of said plurality of predetermined sections of said surface of said second bed and replacing said at least one of said plurality of predetermined sections of said surface of said first bed with at least one of said plurality of predetermined sections of said surface of said second bed without requiring a movement from said patient and without causing any movement to the body of said patient and without lifting said patient.

37. The system according to claim 35, wherein said plurality of predetermined sections of said surface of said first bed and at least one of said plurality of predetermined sections of said surface of said second bed are vertically moved down and vertically moved by a manual jack, a motor or a gear box.

38. The system according to claim 35, wherein said plurality of predetermined sections of said surface of said first bed and at least one of said plurality of predetermined sections of said surface of said second bed are vertically moved down and vertically moved by a plurality of pneumatic jacks.

39. The system according to claim 35, wherein said pluralities of predetermined sections of said surface said first bed and said pluralities of predetermined sections of said surface of second bed have a center base provided with a central axial hole to receive a rod, a vertical hole connected to said central axial hole, a ball bearing assembly arranged in said vertical hole, a groove arranged over said vertical hole and a metal locking pin provided in said groove.

40. The system according to claim 35, further comprises:
a first axle rod and a second axle rod dedicate to said first bed;
a first plurality of rods wherein each of said first plurality of rods comprises a first end and a second end wherein said first end is attached to said first axle rod of said first bed;
a second plurality of rods wherein each of said second plurality of rods comprises a first end and a second end wherein said first end is attached to said second axle rod of said first bed.

41. The system according to claim 40, wherein said first plurality of predetermined sections of said first bed are attached to said first plurality of rods of said first bed and a second plurality of predetermined sections of said first bed are attached to said second plurality of rods of said first bed respectively.

42. The system according to claim 35, further comprises:
a first axle rod and a second axle rod dedicated to said second bed;
a first plurality of rods wherein each of said first plurality of rods comprises a first end and a second end wherein said first end is attached to said first axle rod of said second bed;
a second plurality of rods wherein each of said second plurality of rods comprises a first end and a second end wherein said first end is attached to said second axle rod of said second bed.

43. The system according to claim 42, wherein said first plurality of predetermined sections of said second bed are attached to said first plurality of rods of said second bed and a second plurality of predetermined sections of said second bed are attached to said second plurality of rods of said second bed respectively.

44. The system according to claim 39 further comprises a means for securing said base center to said rods.

45. The system according to claim 35, wherein said first bed and said second bed has four recessed bed plates to hold and support a plurality of pneumatic jacks respectively in place.

46. The system according to claim 35, wherein both said first bed and said second bed has a first palette and a second palette.

47. The system according to claim 46, wherein said first palette and said second palette of said first bed comprises said pluralities of predetermined sections of said surface said first bed and said first palette and said second palette of said second bed comprises said pluralities of predetermined sections of said surface of second bed.

48. The system according to claim 46, wherein said first palette and said second palette of said first bed has a U-shaped frame which is fixed to said pluralities of pneumatic jacks so that said first palette and said second palette of said first bed is moved up or down in a vertical direction by said pluralities of pneumatic jacks.

49. The system according to claim 48, wherein each of said pluralities of pneumatic jacks has two air pressure inlets to move a cylinder in each said pneumatic jack up or down.

50. The system according to claim 35, further comprises two mechanical taps connected respectively to said pluralities of pneumatic jacks connected to said first palette and said second palette of said first bed through a respective hose.

51. The system according to claim 50, wherein each of said two mechanical taps is connected to a compressor through a respective connecting hose.

52. The system according to claim 50, wherein each of said two mechanical taps has a control lever to enable a routing of a predetermined amount of air pressure from said compressor to said pluralities pneumatic jacks to move down or move up said first palette or second palette.

53. The system according to claim 50, wherein said each of said two mechanical taps has one inlet hole connected to said compressor and two outlet holes connected said pluralities of pneumatic jacks which are coupled to said first palette or said second palette so that said control lever is lowered or raised to permit an air through either of said two outlet holes to move up or move down a cylinder in each said pneumatic jack in said pluralities of jacks.

54. The system according to claim 46, wherein said first palette of said second bed comprises a rigid frame mounted with wheels and pluralities of rods to receive said pluralities of planks.

55. The system according to claim 46, wherein said second palette of said second bed has a U-shaped frame which is fixed to said pluralities of pneumatic jacks so that said second palette of said second bed is moved up or down in a vertical direction by said pluralities of pneumatic jacks.

56. The system according to claim 55, wherein each of said pluralities of pneumatic jacks has two air pressure inlets to move a cylinder in each said pneumatic jack up or down.

57. The system according to claim 55, further comprises a mechanical taps connected to said pluralities of pneumatic jacks connected to said second palette of said second bed through a respective hose.

58. The system according to claim 57, wherein said mechanical tap is connected to a compressor through a respective connecting hose.

59. The system according to claim 57, wherein said mechanical tap has a control lever to enable a routing of a predetermined amount of air pressure from said compressor to said pluralities pneumatic jacks to move down or move up said second palette.

60. The system according to claim 57, wherein said mechanical tap has one inlet hole connected to said compressor and two outlet holes connected to said pluralities of pneumatic jacks which are coupled to said second palette so that said control lever is lowered or raised to permit an air through either of said two outlet holes to move up or move down a cylinder in each said pneumatic jack in said pluralities of jacks.

61. The system according to claim 46, wherein said first palette and said second palette of said first bed and said second bed comprises a plurality of planks placed in an inter digital position so that said planks are separated by an equal space.

62. The system according to claim 61, wherein each plank in said plurality of planks is a two dimensional plank.

63. The system according to claim 62, wherein said two dimensional plank is a rectangular plank.

64. The system according to claim 61, wherein each plank in said plurality of planks is a three dimensional plank.

65. The system according to claim 64, wherein said three dimensional plank is a triangular plank.

66. The system according to claim 62, wherein each said plank comprises a center base provided with a central axial hole which acts as a rotating center, a soft permanent cover arranged over said center base and a removable, changeable bed sheet arranged over the soft permanent cover.

67. The system according to claim 62, wherein each said plank is fitted with a separate bed sheet so that each said plank is rotated separately to provide a clean surface always under said patient.

68. The system according to claim 62, wherein each said plank is removable.

69. The system according to claim 46, wherein said first palette and said second palette in said first bed and said second bed is moved interchangeably downwards.

70. The system according to claim 46, wherein said first palette and said second palette has a pluralities of rods attached to said frame structure to hold and receive said pluralities of planks respectively.

71. The system according to claim 70, wherein each rod in said pluralities of said rods is received into said hole in said base center in each said plank to hold each said plank with each of said first palette and said second palette and to rotate each said plank with each of said first palette and said second palette

72. The system according to claim 71, wherein each said rod has three holes positioned at equal distances to each other to receive a ball bearing assembly to ensure a stable positioning of each said plank on each said rod to prevent unwanted movements.

73. The system according to claim 72, wherein said ball bearing assembly has a spring and a round metal ball positioned inside a hole arranged in said base center of each said plank.

74. The system according to claim 73, wherein said hole has a groove in the upper part to keep a curved metal spring in place to prevent said spring from being dislodged from said hole.

75. The system according to claim 72, wherein said hole has an indention to keep said metal ball in place.

76. The system according to claim 72, wherein said three holes are provided on said palette axle rod to receive said metal ball to allow a rotation and a removal of said pluralities of planks from said pluralities of rods in said first palette and said second palette so that each said plank in said pluralities of planks is locked in any one of three positions and is rotated through 120 degrees at any one locked position.

77. The system according to claim 46, wherein the second palette of said first bed and said second bed has a pluralities of legs attached to said base frame.

78. The system according to claim 77, wherein said pluralities of the rods are attached to said pluralities of legs to receive and support said pluralities of planks.

79. A system for transferring a patient from one bed to another bed comprising:
a first bed having a plurality of predetermined sections wherein said first bed is stationary and comprises a surface for resting said patient;
a second bed having a plurality of predetermined sections wherein said second bed is moveable and comprises a surface for resting said patient;
a means for combining said surface of said first bed with said surface of said second bed by reducing volume of said plurality of predetermined sections of said surface of said first bed by reducing volume of said plurality of predetermined sections of said surface of said second bed and by inserting said plurality of predetermined sections of said surface of said second bed after a volume reduction into a plurality spaces created between said plurality of predetermined sections of said first bed after a volume reduction without requiring a movement from said patient and without causing any movement to a body of said patient and without lifting said patient.

80. The system according to claim 79, wherein said pluralities of predetermined sections of said surface of said first bed and said pluralities of predetermined sections of said surface of second bed have a center base provided with a central axial hole to receive a rod, a vertical hole connected to said central axial hole, a ball bearing assembly arranged in said vertical hole, a groove arranged over said vertical hole and a metal locking pin provided in said groove.

81. The system according to claim 79, further comprises:
a first axle rod dedicate to said first bed;
a first plurality of rods wherein each of said first plurality of rods comprises a first end and a second end wherein said first end is attached to said first axle rod of said first bed;

82. The system according to claim 79, wherein a first plurality of predetermined sections of said first bed are attached to said first plurality of rods of said first bed.

83. The system according to claim 79, further comprises:
a first axle rod dedicated to said second bed;
a first plurality of rods wherein each of said first plurality of rods comprises a first end and a second end wherein said first end is attached to said first axle rod of said second bed.

84. The system according to claim 79, wherein a first plurality of predetermined sections of said second bed are attached to said first plurality of rods of said second bed.

85. The system according to claim 79, further comprises a means for securing said base center to said rods.

86. The system according to claim 79, wherein both said first bed and said second bed has a first palette.

87. The system according to claim 86, wherein said first palette of said first bed comprises said pluralities of predetermined sections of said surface said first bed.

88. The system according to claim 86, wherein said first palette of said first bed has a U-shaped frame mounted with a pluralities of rods to receive said pluralities of predetermined sections of said surface of said first bed.

89. The system according to claim 86, wherein said first palette of said second bed comprises a rigid frame mounted with wheels and pluralities of rods to receive said pluralities of predetermined sections of said surface of said second bed.

90. The system according to claim 86, wherein said first palette of said first bed and said second bed comprises a plurality of planks placed in an inter digital position so that said plurality of planks are separated by equal space.

91. The system according to claim 90, wherein said plurality of planks are a plurality of air sacks.

92. The system according to claim 90, wherein each plank in said plurality of planks comprises a center base provided with the central axial hole which acts as a rotating center, a soft permanent cover arranged over said center base and a removable, changeable bed sheet arranged over said soft permanent cover.

93. The system according to claim 90, wherein each said plank in plurality of planks is removable.

94. The system according to claim 86, wherein said first palette of said first bed and said first palette of said second bed has a pluralities of rods attached to frame structure to hold and receive said pluralities of planks.

95. The system according to claim 94, wherein each said rod in said pluralities of rods is received into said hole in said base center in each said plank to hold each said plank with said first palette in said first bed and said second bed.

96. The system according to claim 94, wherein each said rod has three holes positioned at equal distances to receive said ball bearing assembly to ensure a stable positioning of each said plank on each said rod to prevent unwanted movements.

97. The system as claimed in claim 91, wherein said pluralities of air sacks are removable and each air sack in said pluralities of air sacks comprises a base center, a first cover and a second cover, wherein said second cover covers said first cover.

98. The system as claimed in claim 97, wherein said second cover is changeable and is a temporary cover.

99. The system as claimed in claim 97, wherein said each air sack is comprised of a base center which is embraced by a plurality of small air bags wherein said plurality of small air bags are covered by said second covers.

100. The system as claimed in claim 79, further comprises a means for adjusting volume of said pluralities of predetermined sections.

101. The system according to claim 79, wherein volume of said pluralities of predetermined sections of said first bed and said second bed are reduced and increased by removing air or passing air into said pluralities of predetermined sections.

102. The system according to claim 97, said each air sack further comprises a plurality of air tubes and a divider.

103. The system according to claim 99, wherein the base center is made of a hard solid material with a hole in center to receive said rod in said first palette and said second palette.

104. The system according to claim 96, wherein said ball bearing assembly is provided in said hole to prevent said plurality of air sacs from moving loosely or from falling out of said rod in said first palette and said second palette.

105. The system according to claim 96 wherein said ball bearing assembly has a spring and a round metal ball positioned inside said hole arranged in said base center.

106. The system according to claim 105, wherein said hole has a groove in upper part to keep a curved metal spring in place to prevent said spring from being dislodged from said hole.

107. The system according to claim 105, wherein said hole has an indention to keep said metal ball in place.

108. The system according to claim 96, wherein said three holes are provided on said axle rod in said first palette to receive said metal ball to allow a rotation and a removal of each said air sacs from said rod in said first palette so that said air sacs is locked in any one of said three positions and is rotated through 120 degrees at any one locked position.

109. The system according to claim 102, wherein said pluralities of air tubes are cylindrical sacks which are elastic and are positioned around said base center.

110. The system according to claim 102, wherein compressed air is passed into said pluralities of air tubes through an inlet hole to increase a volume and compressed air is emptied from said pluralities of air tubes to decrease a volume to make said pluralities of air tubes to rest on said base center.

111. The system according to claim 102, wherein said divider has an inlet hole and a pluralities of outlet holes connected respectively to said inlet hole in each of said pluralities of air tubes to route compressed air to all said pluralities of air tubes simultaneously.

112. The system according to claim 97, wherein said secondary cover comprises a textile material to cover each of said pluralities of air sacks all around to protect said pluralities of air sacs from contamination and dirt.

113. The system according to claim 97, wherein said secondary cover comprises a sheet having pluralities of holes to receive said axle rod in said first palette and said inlet holes of said divider.

114. The system according to claim 79 further comprises a mechanical tap with a pump handle to route compressed air to said pluralities of air tubes inside said pluralities of air sacs through a connecting hose.

115. The system according to claim 114, wherein said mechanical tap has an inlet hole connected to said air compressor and two outlet holes so that said compressed air enters said pluralities of air sacs through one outlet hole, when said pump handle is raised and said compressed air exits said pluralities of air sacs through another outlet hole when said pump handle is lowered.

116. The system according to claim 79 further comprises 3-way connectors to distribute air simultaneously and equally to all said pluralities of air sacs.
